(19) United States
(12) Patent Application Publication
(10) Pub. No.: US 2023/0328814 A1
(43) Pub. Date: Oct. 12, 2023

(54) METHOD AND NODE FOR COMMUNICATION IN COMMUNICATION SYSTEM SUPPORTING INTEGRATED ACCESS AND BACKHAUL (IAB)

(71) Applicant: Samsung Electronics Co., Ltd., Suwon-si, Gyeonggi-do (KR)

(72) Inventors: Weiwei WANG, Beijing (CN); Hong WANG, Beijing (CN); Lixiang XU, Beijing (CN)

(21) Appl. No.: 18/016,620

(22) PCT Filed: Jul. 16, 2021
(86) PCT No.: PCT/KR2021/009203

§ 371 Date: Jan. 17, 2023

(30) Foreign Application Priority Data
Jul. 17, 2020 (CN) 202010694687.9
Jan. 8, 2021 (CN) 202110026268.2

(51) Int. Cl. H04W 76/12; H04L 1/08

(52) U.S. Cl. CPC H04W 76/12; H04L 1/08

(57) ABSTRACT

A method performed by a receiving node and a transmitting node in a communication system supporting integrated access and backhaul (IAB), the receiving node and the transmitting node are provided. The method performed by the receiving node comprises: receiving a configuration request message from a transmitting node; and performing configuration of data duplication on a radio bearer based on the received configuration request message; wherein the configuration request message may be a first resource configuration request message, and wherein the first resource configuration request message comprises at least one of the following: first configuration information related to the radio bearer; and first configuration information related to a backhaul link channel, for the receiving node to generate configuration information related to the backhaul link channel.

### CROSS-REFERENCE TO RELATED APPLICATION(S)

This application is a U.S. National Stage application under 35 U.S.C. § 371 of an International application number PCT/KR2021/009203, filed on Jul. 16, 2021, which is based on and claims priority of a Chinese patent application number 202010694687.9, filed on Jul. 17, 2020, in the Chinese Intellectual Property Office, and of a Chinese patent application number 202110026268.2, filed on Jan. 8, 2021, in the Chinese Intellectual Property Office, the disclosure of each of which is incorporated by reference herein in its entirety.

### TECHNICAL FIELD

This application relates to wireless communication technology, and in particular to an interactive device and method between a base station and a user equipment.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

Wireless communication is one of the most successful innovations in modern history. Recently, the number of user equipments of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, the demand for wireless data traffic is growing rapidly. In order to meet the rapid growth of mobile data traffic and support new applications and deployments, it is critical to improve the efficiency and coverage of wireless interfaces.

In the 5G network, in order to extend the coverage of the network, the subject of Integrated Access and Backhaul (IAB) is proposed. The main purpose of the subject is to build a multi-hop network architecture, that is, user data is transmitted through one or more intermediate nodes (such as IAB nodes). At the same time, in order to ensure the reliability of user data transmission, in the 5G system, a data packet duplication function (such as Packet Data Convergence Protocol (PDCP) duplication function) is introduced, that is, a data packet may be duplicated into multiple copies, which are then transmitted in the network. When a 5G base station comprises a central unit and a distributed unit, the duplicated data packets may be transmitted between the central unit and the distributed unit through multiple tunnels.

In the prior art, in order to support the duplication function of a user data packet, the enhancement of the central unit and the distributed unit of the base station and the enhancement of the air interface between the base station and the user equipment are mainly considered. However, the data transmission between the central unit and the distributed unit of the base station is performed according to the existing wired network mechanisms. After the introduction of the IAB network, the duplicated data packets need to be forwarded through one or more intermediate nodes, which is done through radio links between the intermediate nodes. Therefore, the prior art does not consider how to forward these duplicated data packets through a radio link. For example, the prior art does not consider how to duplicate the data packets among the intermediate nodes, and how to transmit the data packets received by the node to which the user accesses to other nodes or users.

In addition to the data packet duplication function, for the transmission of control signaling messages (such as RRC messages), the 5G system also introduces the segmentation feature of the control signaling messages. The main function of this feature is to divide a larger control signaling message into multiple segments, and then each of the segments is transmitted by another control signaling message. This feature is proposed to adapt to the limitation of the data packet size in the existing protocol systems. Through the segmentation feature, the control signaling may be efficiently transmitted between the base station and the user equipment, avoiding the problem that the user equipment or the base station cannot be configured due to the limitation of the data packet size. This segmentation feature may be applied not only to common single-hop networks, but also to multi-hop networks (such as IAB networks).

In the prior art, the segmentation feature of the control signaling messages is only for the base station with a non-split structure (that is, the base station is not composed of a central unit and a distributed unit, rather is an integral functional entity). However, when the base station comprises a central unit and a distributed unit, or when a user equipment is served by multiple base stations, since the information in the control signaling messages may be generated by different nodes, and these nodes do not know the limitation of the size of the control signaling messages, the information generated by one of the nodes thus may cause the size of the control signaling messages to exceed the limitation, leading to failure of transmission of the control signaling. Therefore, in the case of a base station split architecture or service by multiple base stations, the prior art still fails to well support the segmentation feature of the control signaling messages.

### DISCLOSURE OF INVENTION

### Technical Problem

The aspect of the present disclosure is to address the issue that how to duplicate a data packet of a user and transmitted the duplicated data packets over radios links between intermediate nodes when the user accesses a network through one or more intermediate nodes.

The present disclosure provides a method and apparatus for communication in a communication system supporting integrated access and backhaul (IAB).

### Solution to Problem

The present disclosure comprises four aspects: configuration of user data transmission on base station side; configuration of user data transmission on central unit side of base station; activation and deactivation of downlink data packet duplication; and activation and deactivation of uplink data packet duplication.

According to an aspect of the present disclosure A method performed by a receiving node in a communication system supporting integrated access and backhaul (IAB) is provided, wherein the method may comprise: receiving a configuration request message from a transmitting node; and performing a data duplication configuration on a radio bearer based on the received configuration request message;

Wherein the configuration request message may be a first resource configuration request message, wherein the first resource configuration request message may comprise at least one of the following: first configuration information related to the radio bearer; and first configuration information related to a backhaul link channel, for the receiving node to generate configuration information related to the backhaul link channel.

Alternatively, the configuration request message is a second resource configuration request message, which is used to notify the receiving node of configuration information about downlink data transmission, wherein the second resource configuration request message comprises at least one of the following: the identification information of the radio bearer and the information related to the tunnel of the radio bearer.

Alternatively, the configuration request message may be a first configuration message, which is used to help the receiving node determine a transmission method of user data on the access link, wherein the first configuration message may comprise at least one of the following: indication information of duplication of data; and indication information of the number of copies that data to be duplicated into.

Alternatively, the configuration request message may be a second configuration message, which is used to help the receiving node determine a transmission method of user data on the backhaul link, wherein the second configuration message may comprise at least one of the following: indication information of duplication of data; and indication information of the number of copies that data to be duplicated into.

According to an aspect of the present disclosure, there is provided a receiving node in a communication system supporting integrated access and backhaul (IAB), which may comprise: a transceiver; and a processor configured to receive a configuration request message from a transmitting node through the transceiver, and perform configuration of data duplication on a radio bearer based on the received configuration request message., wherein the receiving node may be a relay node or a distributed unit function of the relay node or a distributed unit of an anchor node or a user plane part of a central unit of the anchor node.

According to an aspect of the present disclosure, there is provided a transmitting node, which may comprise: a transceiver; and a processor configured to: transmit a configuration request message to a receiving node through the transceiver, for the receiving node to perform configuration of duplication of data of a radio bearer, wherein the transmitting node may be a central unit of an anchor node, control plane part of the central unit of the anchor node, or user plane part of the central unit of the anchor node.

According to another aspect of the present disclosure, an advantage of the present disclosure is to ensure that a size of a control signaling message does not exceed a limit among multiple nodes.

A data transmission method among multiple nodes that ensures a size of a control signaling message does not exceed a limit is provided, the method comprising: receiving by a fifth node a configuration request message from a fourth node; and transmitting by the fifth node a configuration response message to the fourth node.

The configuration request message may be a first data configuration request message. The first data configuration request message is used to notify the fifth node of configuration information required in generating information in the control signaling message;

wherein, the first data configuration request message comprises at least one of the following information: first capability information, which is used to indicate whether a node that generates the control signaling message has an ability to perform segmentation; first information indicating a size, which is used to indicate an allowed size of the control information when the fifth node generates the control information; second information indicating a size, which is used to indicate a size of the control information generated by the fourth node; first signaling information, which contains a first control signaling message and/or a second control signaling message generated by the fourth node; and second signaling information, which contains control signaling messages generated by other nodes.

In a further embodiment, the first signaling information may comprise multiple containers, each of which may comprise a second control signaling message that carries a segment of the first control signaling message;

wherein, the configuration response message may be a first data configuration response message, which is used to notify the fourth node of information in the control signaling message generated, and the message comprises at least one of the following information: cause information, a function of which is to indicate cause information of the information contained in the first data configuration response message; and first configuration control information, which is configuration information generated by the fifth node, and information contained in this configuration information may be included in the first control signaling message or the second control signaling message and then transmitted to a user equipment.

In a further embodiment, in the case of the F1 interface, the first configuration control information may comprise multiple DU to CU RRC Information IEs, and these IEs include all the control information required to configure the user; while in the case of the Xn/X2 interface, the first configuration control information may include multiple Secondary Node to Master Node container IEs, and these IEs contain all the control information required to configure the user equipment.

In an embodiment, the fourth node and the fifth node may be a central unit (or control plane part of the central unit) of the base station and a distributed unit of the base station, respectively, and a size limit of the control information generated by the distributed unit is configured by the central unit.

In another embodiment, the information of a size allowed when the distributed unit of the base station generates the control information is configured by OAM, and therefore, the distributed unit may generate control information based on this information.

In another embodiment, the fourth node and the fifth node may be a master node and a secondary node, respectively, or a source node and a target node, respectively.

In another embodiment, the fourth node and the fifth node may be a master node and a secondary node, respectively, or a source node and a target node, respectively, wherein OAM configures the information of the size allowed when the secondary node (or target node) generate the control information.

In another embodiment, the fourth node and the fifth node may be central units (or control plane part of the central units) of a master node (or a source node) and a secondary node (or a target node), respectively; or may be a central unit (or control plane part of the central unit) of a secondary node (or a target node) and a distributed unit of the secondary node (or a target node), respectively.

In another embodiment, the fourth node and the fifth node may be central units (or control plane part of the central units) of a master node (or source node) and a secondary node (or target node), respectively; or may be a central unit (or control plane part of the central unit) of a secondary node (or a target node) and a distributed unit of the secondary node (or the target node), respectively, wherein, a size limit of the control information is set by OAM.

In an embodiment, a method comprises: transmitting by a fourth node a first data configuration request message to a fifth node; and transmitting by the fifth node the received control signaling messages to a user equipment one by one;

Wherein the fourth node and the fifth node may be a central unit and a distributed unit of a base station, respectively.

In a further embodiment, the first data configuration request message comprises first information containing a plurality of segments of the first control signaling message.

In an embodiment, the first data configuration request message may be a DL RRC Message Transfer message of the F1 interface.

In one embodiment, for a dual connectivity scenario, the fourth node may be a master node (or a central unit of the master node, or control plane part of the central unit of the master node), and the fifth node may be a secondary node (or a central unit of the secondary node, or control plane part of the central unit of the secondary node).

In another embodiment, for a handover scenario, the fourth node may be a source node (or a central unit of the source node, or control plane part of the central unit of the source node), and the fifth node may be a target node (or a central unit of the target node, or control plane part of the central unit of the target node).

In another embodiment, the first data configuration request message and the first data configuration response message may be non-user equipment-associated messages. Specifically, they may be: a Xn/X2 Setup Request and a Xn/ X2 Setup Response message, a NG-RAN Node/eNB Configuration Update and a NG-RAN Node/eNB Configuration Update Acknowledge message, respectively. In an alternative embodiment, the first data configuration request message and the first data configuration response message may be user equipment-associated messages. Specifically, they may be: Handover Request and Handover Request Acknowledge messages respectively. In an alternative embodiment, the first data configuration request message and the first data configuration response message may be newly defined messages.

In various embodiments, for a base station with a CU-DU split architecture, the fourth node may be a central unit of the base station, and the fifth node may be a distributed unit of the base station.

According to another aspect of the present disclosure, a method is provided, the method comprising: transmitting by a sixth node a second data configuration request message to a fourth node, transmitting by the fourth node a first data configuration request message to a fifth node, transmitting by the fifth node a first data configuration response message to the fourth node, and transmitting by the fourth node a second data configuration response message to the sixth node.

In a further embodiment, the size limit of the control information used to generate a control signaling message of an appropriate size is set by the master node and/or the central unit of the master node or the control plane part of the central unit of the master node and/or OAM.

In a further embodiment, the sixth node may be a source node or the central unit of the source node, or the control plane part of the central unit of the source node, the fourth node may be the central unit of the target node or the control plane part of the central unit, and the fifth node may be the distributed unit of a target node.

In a further embodiment, the size limit of the control information used to generate a control signaling message of an appropriate size is set by the source node and/or the central unit of the source node and/or the control plane part of the central unit of the source node and/or the OAM.

In a further embodiment, the sixth node may be the master node or the central unit of the master node, or the control plane part of the central unit of the master node, the fourth node may be the central unit of the secondary node or the control plane part of the central unit, and the fifth node may be the distributed unit of the secondary node.

In a further embodiment, the first data configuration request message and the first data configuration response message may be non-user equipment-associated F1 messages. Specifically, they may be: a GNB-CU Configuration Update and a GNB-CU Configuration Update Acknowledge message respectively. In an alternative embodiment, the first data configuration request message and the first data configuration response message may be user equipment-associated F1 messages. Specifically, they may be: a UE Context Setup/Modification Request message and a UE Context Setup/Modification Response message, respectively. In an alternative embodiment, the first data configuration request message and the first data configuration response message may be newly defined messages.

In a further embodiment, the second data configuration request message and the second data configuration response message may be non-user equipment-associated messages. Specifically, they may be: a Xn/X2 Setup Request and a Xn/X2 Setup Response message, respectively; or they may be: NG-RAN Node/eNB Configuration Update and NG-RAN Node/eNB Configuration Update Acknowledge message, respectively. In an alternative embodiment, the second data configuration request message and the second data configuration response message may also be user equipment-associated messages. Specifically, they may be: a S-Node Addition/Modification Request and S-Node Addition/Modification Response message, respectively; or they may be: a Handover Request and a Handover Request Acknowledge message, respectively. In an alternative embodiment, the second data configuration request message and the second data configuration response message may also be newly defined messages. According to another aspect of the present disclosure, there is provided a method, the method comprising: transmitting by a fourth node a third data configuration request message to a seventh node, the message being used to transmit configuration information related to user equipment’s handover; and after receiving the above message, transmitting by the seventh node a first handover configuration information related to the handover to a target node.

In a further embodiment, the seventh node may be a node of the core network, which comprises at least one of the following: Access and Mobility Management Function (AMF) and Mobility Management Entity (MME).

In a further embodiment, the third data configuration request message may be a Handover Required message in TS38.413 or TS36.423.

According to another aspect of the present disclosure, there is provided a method, the method comprising: transmitting a fourth data configuration request message by a seventh node to a fifth node, the message being used to transmit configuration information related to user equipment’s handover; and after receiving the above message, generating by the fifth node second handover configuration information related to the handover.

In a further embodiment, the seventh node is a node of the core network, and comprises at least one of the following: AMF and MME.

In a further embodiment, the fourth data configuration request message may be a Handover Request message in TS38.413 or TS36.423.

### BRIEF DESCRIPTION OF DRAWINGS

FIG. 1 is an exemplary system architecture of System Architecture Evolution (SAE);

FIG. 2 is an exemplary architecture of a 5G system;

FIG. 3 is an example of a base station structure;

FIG. 4 is an example of a relay network;

FIG. 5 is an example of user data duplication;

FIG. 6a is an example of user data duplication in a relay network;

FIG. 6b is an example of control signaling message segmentation;

FIG. 7 is an example of the process of a first aspect of the present disclosure;

FIG. 8 is an example of the process of a second aspect of the present disclosure;

FIG. 9 is an example of the process of a third aspect of the present disclosure;

FIG. 10 is an example of the process of a fourth aspect of the present disclosure;

FIG. 11 is an example of the process of a fifth aspect of the present disclosure;

FIG. 12 is a first process example related to transmitting control signaling message segmentation according to the present disclosure;

FIG. 13 is a second process example related to transmitting control signaling message segmentation according to the present disclosure;

FIG. 14 is a third process example related to transmitting control signaling message segmentation according to the present disclosure;

FIG. 15 is a fourth process example related to transmitting control signaling message segmentation according to the present disclosure; and

FIG. 16 is a fifth process example related to transmitting control signaling message segmentation of the present disclosure.

### MODE FOR THE INVENTION

The embodiments are described below only by referring to the figures to explain various aspects. As used herein, the term “and/or” comprises any and all combinations of one or more of the associated listed items. Expressions such as “at least one” when preceding a list of elements modify the entire list of elements without modifying individual elements of the list, so that expressions of “at least one of a, b, and c” or similar expressions comprise only a, only b, only c, only a and b, only a and c, only b and c, and all of a, b, and c.

The terms used in this specification will be briefly described, and the present disclosure will be described in detail.

Regarding the terms in the various embodiments of the present disclosure, in consideration of the functions of the structural elements in the various embodiments of the present disclosure, general terms that are currently widely used are selected. However, the meaning of terms may be changed according to intentions, judicial precedents, the emergence of new technologies, etc. In addition, in some cases, uncommon terms may be chosen. In such a case, the meanings of the terms will be described in detail in the corresponding part in the description of the present disclosure. Therefore, the terms used in the various embodiments of the present disclosure should be defined based on the meaning and description of the terms provided herein.

Any embodiment disclosed herein may be combined with any other embodiments, and references to “an embodiment”, “some embodiments”, “alternative embodiments”, “various embodiments”, “one embodiment”, etc. are not mutually exclusive, but it is intended to indicate that a particular feature, structure, or characteristic described in connection with this embodiment may be included in at least one embodiment. Such terms used herein do not necessarily all refer to the same embodiment. Any embodiment may be combined inclusively or exclusively with any other embodiment in a manner consistent with the aspects and embodiments disclosed herein.

References to “or” may be construed as inclusive, so that any term described using “or” can indicate any one of a single, more than one, and all of the items.

Terms including ordinal numbers (such as first, second, etc.) may be used to describe various elements, but these elements are not limited by the terms. The above terms are only used to distinguish one element from another element. For example, without departing from the scope of the present disclosure, a first element may be referred to as a second element, and similarly, a second element may also be referred to as a first element. The term “and/or” comprises any combination of multiple related items or any one of the multiple related items.

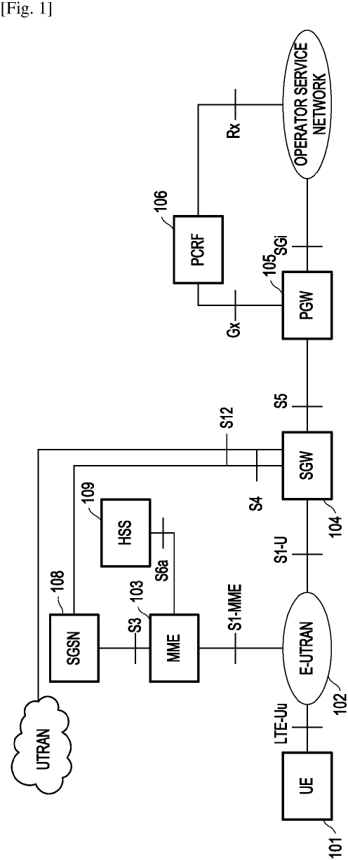

FIGS. 1 to 16 discussed below and various embodiments used to describe the principle of the present disclosure in this patent document are only for illustration, and should not be construed as limiting the scope of the present disclosure in any way. Those skilled in the art will understand that the principles of the present disclosure may be implemented in any suitably arranged system or device.

FIG. 1 is an exemplary system architecture 100 of System Architecture Evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with an interface for accessing to the radio network. A mobility management entity (MME) 103 is responsible for managing the mobility context, session context and security information of the UE. A serving gateway (SGW) 104 mainly provides function of user plane, and the MME 103 and the SGW 104 may be in a same physical entity. A packet data network gateway (PGW) 105 is responsible for charging, lawful interception, etc., and may be in the same physical entity as SGW 104. A policy and charging rules function entity (PCRF) 106 provides quality of service (QoS) policies and charging rules. A general packet radio service support node (SGSN) 108 is a network node device that provides routing for data transmission in universal mobile telecommunications system (UMTS). A home subscriber server (HSS) 109 is a home subsystem of the UE, and is responsible for protecting user information including the current location of the user equipment, address of a serving node, user security information, and packet data context of the user equipment.

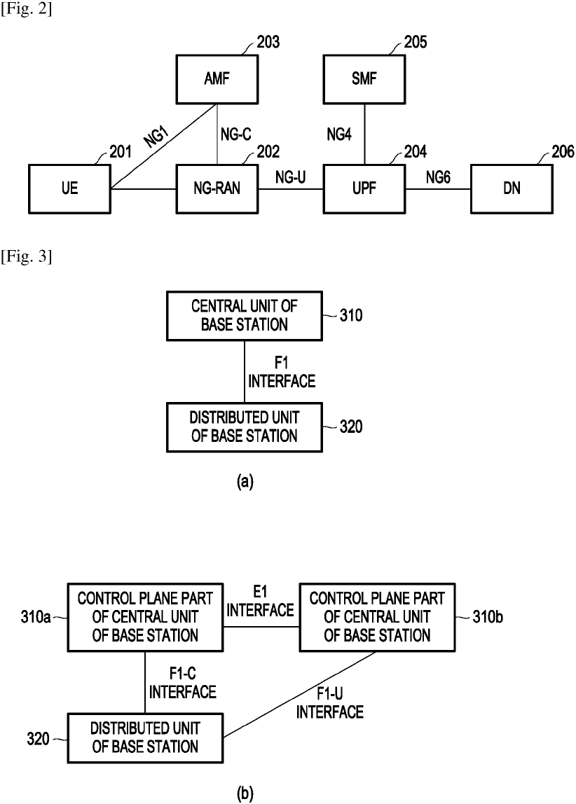

FIG. 2 is an exemplary system architecture 200 according to various embodiments of the present disclosure. Other embodiments of the system architecture 200 may be used without departing from the scope of this disclosure.

User equipment (UE) 201 is a terminal device for receiving data. The next generation radio access network (NG-RAN) 202 is a radio access network, which includes a base station (gNB or an eNB connected to a 5G Core network (5GC) which is also called ng-gNB) that provides UE with an interface for accessing the radio network. An access control and mobility management functional entity (AMF) 203 is responsible for managing the mobility context and security information of the UE. A user plane function entity (UPF) 204 mainly provides functions of a user plane. A session management function entity (SMF) 205 is responsible for session management. A data network (DN) 206 includes services of operators, Internet access and services of third parties.

FIG. 3 shows two possible structures of a base station in a 5G network. FIG. 3(a) shows that a base station comprises a central unit 310 of the base station (such as gNB-Central Unit, gNB-CU) and a distributed unit 320 of the base station (such as gNB-Distributed Unit, gNB-DU). The central unit 310 of the base station comprises following protocol stacks: a protocol stack of a service control plane, which comprises a Radio Resource Control (RRC) protocol layer and a Packet Data Convergence Protocol (PDCP) layer; and a protocol stack of a service user plane, which comprises a Service Data Adaptation Protocol (SDAP) layer and a PDCP layer. The distributed unit 320 of the base station comprises following protocol stacks: protocol stacks of service control plane and user plane, which comprise a Radio Link Control (RLC) protocol layer, a Medium Access Control (MAC) protocol layer, and a physical layer (PHY). The interface between the central unit of an anchor node and the distributed unit of the anchor node, and the interface between the central unit of the anchor node and the distributed unit of the relay node are F1 interfaces (see 3GPP TS38.473).

FIG. 3(b) shows that a base station comprises the control plane part 310a of the central unit of the base station (such as gNB-CU-CP (gNB-CU-Control Plane)), and the user plane part 310b of the central unit of the base station (such as gNB-CU-UP (gNB-CU-User Plane)), and the distributed unit 320 of the base station. The control plane part 310a of the central unit of the base station comprises the Radio Resource Control (RRC) protocol layer and the Packet Data Convergence Protocol (PDCP) layer, and the user plane part 310b of the central unit of the base station comprises the Service Data Adaptation Protocol (SDAP) layer and the PDCP layer. The interface between the control plane part 310a of the central unit of the base station and the user plane part 310b of the central unit of the base station is an E1 interface (referring to 3GPP TS38.463).

FIG. 4 shows a schematic architecture of a multi-hop network. The figure shows a network architecture including an anchor node (IAB anchor node (IAB donor)) and two relay nodes (IAB nodes). A user equipment 440a, 440b, 440c in the multi-hop network may access the network through the anchor node or the distributed unit of the anchor node or the relay nodes. For example, user equipment 1/2/3 440a, 440b, 440c access the relay network through the distributed unit of the anchor node 410, the distributed unit part of relay node 1 420, or the distributed unit part of relay node 2 430, respectively. The anchor node 410 may be a standalone base station, or may be a base station composed of a central unit CU (IAB anchor node central unit (IAB-donor central unit)) and a distributed unit DU (IAB anchor node distributed unit (IAB-donor distributed unit)). The relay node 420, 430 comprises the mobile terminal function (MT function, such as the IAB-MT function of IAB-node) and the distributed unit function (DU function, such as IAB-DU function of IAB-node)), wherein the mobile terminal part is used to communicate with the upper-level node of the relay node (for example, the mobile terminal part of relay node 1 420 is used to communicate with the anchor node 410 or the distributed unit of the anchor node 410, and the mobile terminal part of relay node 2 430 is used to communicate with the distributed unit part of relay node 1 420), and the distributed unit part is used to communicate with the lower-level node of the relay node (for example, the distributed unit part of relay node 1 420 is used to communicate with user terminal 2 440b or may be used to communicate with the mobile terminal part of the relay node 2 440b). The mobile terminal function of the relay node 420, 430 may be regarded as a user terminal of an access network, and thus it has the function of a common user terminal (non-relay node) (for example, the mobile terminal part may establish a Signaling Radio Bearer (SRB) with the upper-level node thereof to transmit the RRC messages, or may establish a Data Radio Bearer (DRB) to transmit the data. In the relay network, the link between the relay node 420, 430 and the anchor node 410 or the distributed unit of the anchor node 410, or the link between the relay nodes is a backhaul link, on which one or more different backhaul link channels (Backhaul channels) are established, such as backhaul link channel 1 and backhaul link channel 2 in FIG. 4. An example of the backhaul link channel is a backhaul link radio link control (RLC) protocol layer channel, that is, Backhaul RLC channel. In the relay network, each backhaul link channel is used to transmit data packets belonging to the same user or different users. The data packet may be a data packet of a user Data Radio Bearer (DRB), a data packet of a user Signaling Radio Bearer (SRB), a data packet of control plane on the F1 interface, a data packet of user plane on the F1 interface, or a data packet of non-F1 interface (such as Internet Protocol Security (IPSec) data packet, data packet of SCTP protocol, data packet for OAM (Operation Administration and Maintenance), etc.). When user data is transmitted in the relay network, information related to data packet routing (such as Backhaul Adaptation Layer Routing ID (BAP Routing ID)) will be added to the data packet. The information comprises address information of a target receiving node (such as Backhaul Adaptation Layer Address (BAP address)) and/or path identification information (such as Path ID). The node that receives the user data packet will determine the transmission of the user data according to the information related to the path.

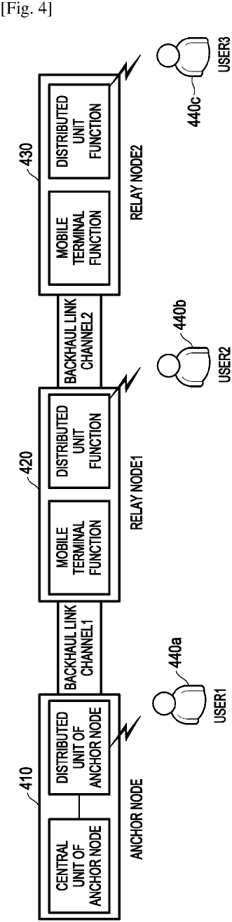

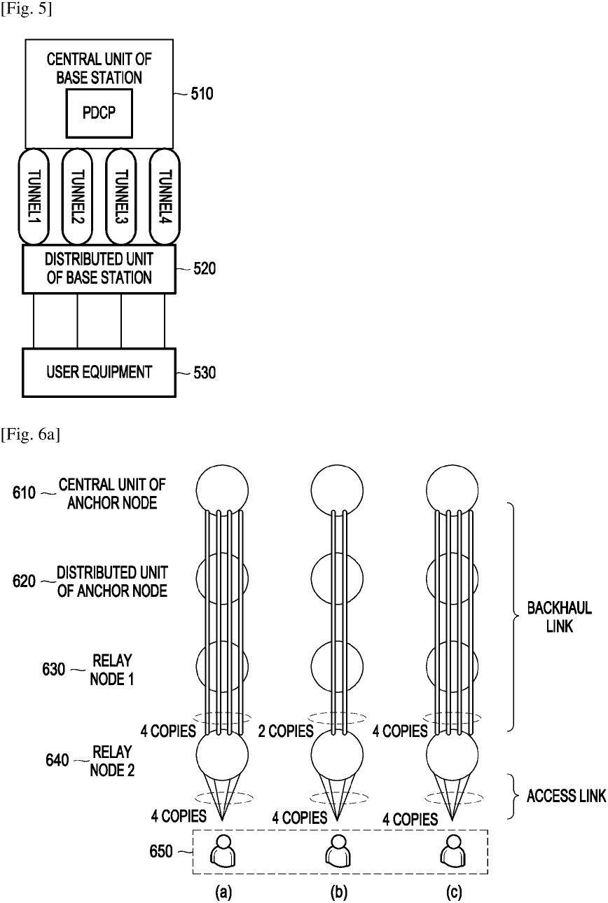

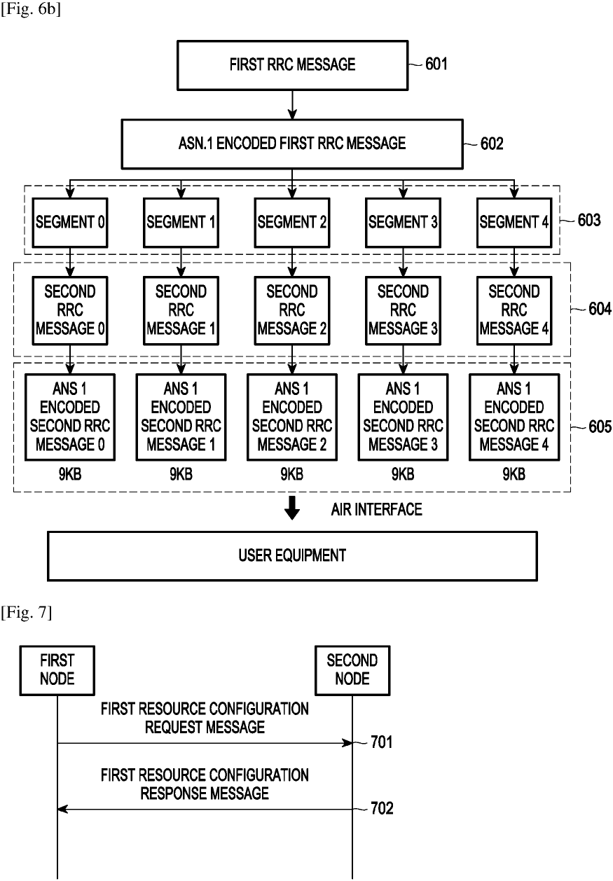

FIG. 5 shows the data packet duplication function in the 5G network. Specifically, when the base station comprises the central unit 510 and the distributed unit 520 of the base station, the user data will be duplicated into multiple copies (such as 4 copies), which are then transmitted between the central unit 510 and the distributed unit 520 of the base station through different tunnels, and are transmitted through different air interface configurations between the distributed unit 520 of the base station and user equipment 530 (such as different RLC entities, logical channels, and cells serving different logical channels). In the prior art, the transmission of user data packets between the central unit and the distributed unit of the base station is performed through a wired network. However, in order to support the duplication function of user data in a relay network (such as an IAB network), user data packets will be transmitted over a radio link. FIG. 6a shows several possible ways. In the figure, the network that the user equipment accesses is a network containing the central unit 610 of the anchor node, the distributed unit 620 of anchor node and two relay nodes 630, 640. The user equipment 650 accesses the network through relay node 2 640 (it should be noted that FIG. 6a is just an example, and in an actual relay network, the relay node that the user accesses may access the anchor node or the distributed unit of the anchor node through one or more other relay nodes, or may be directly connected with the anchor node or the distributed unit of the anchor node). In the present disclosure, the link between the user equipment 650 and the relay node 2 640 is called an access link, and the link between the relay node 2 640 and the relay node 1 630, and between the relay node 1 630 and the distributed unit 620 of the anchor node are called backhaul links. The three ways (a), (b) and (c) shown in FIG. 6a are:

(a) The number of copies of user data transmitted on the backhaul link is the same as the number of copies transmitted on the access link. As shown in (a) of FIG. 6a, the number of copies transmitted on the backhaul link and the number of copies transmitted on the access link are 4.

(b) The number of copies of user data transmitted on the backhaul link is less than the number of copies transmitted on the access link. As shown in (b) of FIG. 6a, the number of copies transmitted on the backhaul link is 2, and the number of copies transmitted on the access link is 4.

(c) The number of copies of user data transmitted on the backhaul link is greater than the number of copies transmitted on the access link. As shown in (c) of FIG. 6a(c), the number of copies transmitted on the backhaul link is 4, and the number of copies transmitted on the access link is 2.

Different from the prior art, the above three methods show that the user data packets will be transmitted between the relay node that the user equipment accesses and the anchor node through the backhaul link. Since the backhaul link is a radio link, the prior art does not have a corresponding mechanism to support the transmission of duplicated data packets on the backhaul link yet, and there is even no corresponding mechanism to support transmission of the duplicated data packets in the backhaul link and access link. Therefore, the present disclosure aims to propose to support transmission of duplicated user data packets on the backhaul link and the access link.

In the NR system, as the functions supported by the system increase, the size of the control signaling messages (such as RRC messages) exchanged between the user equipment and the base station will gradually increase. However, when the control signaling messages are transmitted over the air interface, the size of the data packets is limited (for example, the size of a PDCP SDU containing control signaling messages is 9000 bytes). Therefore, in order to transmit a relatively large control signaling message, NR Rel-16 introduces the control signaling message segmentation feature. Specifically, this feature divides a relatively large RRC message into several smaller data packets, which are then transmitted by multiple RRC messages. Taking the downlink control signaling as an example, the base station divides a larger RRC message (such as RRCReconfiguration or RRCResume) into several data packets, which are then included in multiple RRC messages (such as DLDedicatedMessageSegment) in the form of containers respectively and transmitted to the user equipment. On the user equipment side, the user equipment extracts the data packets contained in these RRC messages, and then assembles them into a complete larger RRC message, and decodes this RRC message.

FIG. 6b gives an example of RRC message segmentation. That is, when the base station transmits a RRC message, the procedure of processing the message is: 601) generating a RRC message; 602) performing ASN.1 encoding on the RRC message; 603) dividing the encoded RRC message into 5 segments; 604) including the 5 segments in 5 DLDedicatedMessageSegment messages respectively; and 605) performing ASN.1 encoding on the 5 DLDedicatedMessageSegment messages, and then transmitting them to the user equipment. In an actual system, the information in a RRC message may be generated by multiple nodes. For example, when a base station comprises a central unit and a distributed unit, the RRC message is ultimately generated by the central unit, but one part of the content in the message is generated by the distributed unit, and another part of the content is generated by the central unit; for another example, When a user equipment is configured for multi-connectivity (such as dual-connectivity), the content of a RRC message may be collectively generated by multiple base stations (such as base station 1, base station 2, etc.) connected with the user equipment. That is, the RRC message is ultimately generated by base station 1, but one part of the content in the message is generated by base station 2, and another part of the content is generated by base station 1. In this way, a problem arises that the information generated by one of the nodes may cause the size of the RRC message to exceed the limit. For example, if node 1 does not support RRC message segmentation, which is not known by node 2, and thus the node 2 will not account for the size of the generated RRC message by the node 1 when generating partial content of the RRC message, causing the RRC message generated by the node 1 to exceed the limit. Therefore, in order to overcome the above-mentioned problems, the present disclosure proposes a method for control signaling message segmentation. This method may be used not only in multi-hop networks (such as IAB networks), but also in single-hop networks.

The message names in the present disclosure are merely examples, and other message names can also be used. The “first”, “second”, etc. in the message names are only used to distinguish different messages, and do not represent the order to transmit the messages.

The different types of nodes involved in the present disclosure include: the base station, a central unit of the base station, control plane part of the central unit of the base stations, user plane part of the central unit of the base station, a distributed unit of the base station, an anchor node, a central unit of the anchor node, control plane part of the central unit of the anchor node, user plane part of the central unit of the anchor node, a distributed unit of the anchor node and a relay node, etc. The above node types are just examples, and the content of the present disclosure is also applicable to other types of nodes.

The data packet duplication function mentioned in the present disclosure is to duplicate a data packet into multiple copies and then transmit them through the network. One embodiment thereof is the duplication of the user data packets of the PDCP layer introduced in the 5G system; but the present disclosure is not limited to this duplication method, and other implementations for duplicating user data may also be applicable.

In the present disclosure, detailed descriptions of steps not related to the present disclosure are omitted.

The present disclosure also uses the following definitions:

Access link: the link used by the user equipment to access the network. If the user equipment accesses the network through the relay node, the access link is the link used by the user equipment to access the distributed unit function of the relay node. In order to implement the transmission of user data on the access link, the network side will provide the user equipment with one or more sets of configuration information (such as RLC-BearerConfig defined in TS38.331). The configuration information comprises at least one of the following information: configuration information of a PDCP entity, configuration information of a RLC entity, and configuration information of a logical channel, etc. In one implementation, the access link channel may represent the PDCP entity and/or RLC entity and/or logical channel used to serve user data; and in another embodiment, the access link channel is used to represent the RLC entity and/or logical channel used to serve user data. The above-mentioned set of configurations is used to configure an access link channel. The network side will configure one or more access link channels for the user equipment. In the prior art, if a radio bearer is not configured with the duplication function, one access link channel is used to serve one radio bearer; and if a radio bearer is configured with the duplication function, two or more access link channels may be configured to serve a radio bearer, each access link channel being used to transmit one copy of a data packet.

Backhaul link: the link used by other nodes that transmit user data. The other nodes may be a node directly connected to the node serving the user equipment access link, or a node that is indirectly connected to the node serving the link accessed by the user equipment (a node connected through one or more nodes). If the user equipment accesses the network through a relay node, the backhaul link is the link used by the mobile terminal function of the relay node. The network side may configure one or more backhaul links to serve a user equipment. For a backhaul link, it may correspond to a set of configuration information. For the content contained in the configuration information, please refer to “Configuration Information related to Backhaul Link” below.

Uplink: the case in which user data is transmitted from the user equipment side to the network side.

Downlink: the case in which user data is transmitted from the network side to the user equipment side.

Configuration Information related to Backhaul Link: this information may include configuration information of one or more backhaul link. For a backhaul link, this information indicates the configuration used when serving user data (such as data on a tunnel). The information comprises at least one of the following information (such as Backhaul Information, BH Information IE in TS38.473):

- Routing identification information (such as routing ID, BAP routing ID). This information indicates the information that needs to be added to the data packet when transmitting data, and furthermore, this information also indicates the routing information used for data transmission. This information comprises path identification information (such as path ID) and/or address information of the target receiving node (such as BAP address). The target receiving node may be the distributed unit of the anchor node or other types of nodes.

- Indication information of backhaul link channel. There may be one or more backhaul link channels, which are the channels on the backhaul link served by a node in the network. In one embodiment, if the node is a distributed unit of an anchor node, the channel is the channel on the backhaul link served by the distributed unit of the anchor node; in another embodiment, if the node is a relay node, the channel is the channel on the backhaul link served by the distributed unit function of the relay node; and in yet another embodiment, if the node is a relay node, the channel is the channel on the backhaul link served by the mobile terminal function of the relay node. For a backhaul link channel, the information comprises at least one of the following information:
> Identification information of backhaul link channel
> dentification information of next hop node. The next hop node is a node that receives user data. In one embodiment, for uplink data, the next hop node may be a distributed unit of other relay nodes or anchor nodes. In another embodiment, for downlink data, the next hop node may be another relay node.
   Indication information of using backhaul link. The indication information may indicate whether the backhaul link may be used (activated or deactivated) for transmission of a data packet, which such as indicates “to use (or activate) a backhaul link” or “not to use (or deactivate) a backhaul link.” The above-mentioned “transmission of a data packet” may refer to transmitting a data packet, or receiving a data packets, or transmitting and receiving a data packet. The backhaul link in the above-mentioned “to use (or activate) a backhaul link” is an available backhaul link; and the backhaul link in the above-mentioned “not to use (or deactivate) a backhaul link” is an unavailable backhaul link.
   Indication information of backhaul link. The indication information is used to identify a backhaul link. In an embodiment, the indication information is the identification information of the backhaul link, and in another embodiment, the indication information is the routing identification information contained in the data packet on the backhaul link. This information comprises the address information of the target receiving node (such as BAP address) and/or path identification information (such as path ID).
   Indication information of access link channel. This indication information is used to indicate one or more access link channels corresponding to the backhaul link, that is, the data transmitted by the backhaul link needs to be transmitted via the access link channel indicated by the indication information. For an access channel, the information comprises at least one of the following information:
> Information about tunnel. The content of this information may refer to “information related to tunnel” below. In one embodiment, the tunnel is used to serve the data on the access link channel.
> Identification information of RLC entity. In one embodiment, the RLC entity is used to serve the access link channel.
> Identification information of logical channel. In one embodiment, the logical channel is used to serve the access channel.
> Path identification information corresponding to access channel. The path is a path of the access link, and the path is used to transmit a copy of the duplicated data packet.

Other identification information. This information is used to identify an access link channel.

In the prior art, only one backhaul link is configured for one tunnel (or uplink tunnel). If the above-mentioned “Configuration Information related to Backhaul Link” is included in the configuration of a tunnel, it is allowed to configure multiple backhaul links for a tunnel, that is, one tunnel may be served by multiple backhaul links. In order to distinguish from the existing technology, in the actual configuration process, a new IE (such as Additional BH information) may be added on the basis of TS38.473 BH Information IE. The function of this IE is to include configuration of one or more additional backhaul links.

Information related to tunnel. For a tunnel, the information comprises at least one of the following information:
Tunnel identification information, such as a tunnel ID.
Internet Protocol (IP) address, which is the address of the node at one end of the tunnel.
Tunnel endpoint identifier of data (TEID, such as GTP-TEID (GTP Tunnel Endpoint Identifier of Data)) information The TEID is the TEID on the node where one end of the tunnel is located.
Configuration information related to backhaul link (such as Backhaul Information, BH Information IE in TS38.473). The configuration information may include configuration information of one or more backhaul links, and each configuration information indicates the configuration of one backhaul link. For the content contained in this information, please refer to the above-mentioned “Configuration Information related to Backhaul Link”. In the prior art, a tunnel can only be configured with one backhaul link; and the present disclosure allows multiple backhaul links to be configured for a tunnel. In order to distinguish from the prior art, in the actual configuration process, a new IE (such as Additional BH information) may be added on the basis of TS38.473 BH Information IE, which is used to include the configuration of one or more additional backhaul links. In an embodiment, if multiple backhaul links are configured in the information, the backhaul links corresponding to the tunnel (or the access link channel corresponding to the tunnel) may be indicated implicitly, and furthermore, it may be implicitly indicated that the data on the tunnel (or the access link channel corresponding to the tunnel) needs to be transmitted by the multiple backhaul links, such as to be transmitted after duplication, each backhaul link being used to transmit one copy.
Identification indication information, which is used to indicate the access link channel corresponding to the tunnel, such as the identification information of RLC entity, the identification information of logical channel, the path identification information corresponding to the access channel, and other identification information, etc. In an implementation, if one or more tunnels contain the same identification indication information, it is indicated that the node receiving the information needs to forward the data on these tunnels to the same access link channel for processing, or duplicate the data processed by the same access link channel and transmit it through the one or more tunnels; and furthermore, for the one or more tunnels, the receiving node only generates configuration information of one RLC entity and/or logical channel when generating configuration information for RLC entities and/or logical channels of these tunnels. This is different from the prior art, which determines the number of RLC entities and/or logical channels according to the number of tunnels.
Routing identification information, which indicates one or more routing identification information contained in the data on the tunnel. For a routing identification, the information comprises the address information of the target receiving node (such as BAP address), and/or path identification information (such as path ID). In one embodiment, the information indicates that all data packets on the tunnel that contain the above-mentioned one or more routing identification information are forwarded to the same access chain channel for processing, or the data of the same access link channel is duplicated and transmitted after containing the above-mentioned routing identification information therein. The information may enable the data on a tunnel to be duplicated into multiple copies and then transmitted on different backhaul links, or the data on an access link channel to be duplicated into multiple copies and then transmitted through different backhaul links. In another implementation, the information indicates that the data packets on the tunnel are handed over to different access link channels for transmission, where if the routing identification contained in the data packets is different, the access link channel used are different; or he data packet on different access link channels will include different routing identification before transmitted on the backhaul links.
Indication information of using tunnel, which may indicate whether the tunnel may be used (activated or deactivated) to transmit data packets, such as “to use (activate) the tunnel”, “not to use (deactivate) the tunnel”; and furthermore, the indication information may also be implicit indication information. In one embodiment, the implicit indication information indicates that the tunnel is not used for transmission of a data packet when the “configuration information related to backhaul link” for the tunnel is not included, and the tunnel is used for transmission of a data packet when the “configuration information related to backhaul link” for the tunnel is included. The above-mentioned “transmission of a data packet” may refer to transmitting a data packet, or receiving a data packet, or transmitting and receiving a data packet. The tunnel in the above-mentioned indication information “to use (or activate) this tunnel” is an available tunnel, and the tunnel in the above-mentioned indication information “not to use (or deactivate) this tunnel” is an unavailable tunnel.
Indication information of duplication of data packet, which indicates whether to duplicate the data transmitted on the tunnel. In one embodiment, if the node that receives the information may duplicate the data packet on the tunnel multiple copies, and then transmit them by different backhaul links respectively, the data packets are from one or more access link channels. In another embodiment, if the node that receives the information may duplicate the data packet on the tunnel multiple copies, and then transmit them by different access link channels respectively, the data packets are from one or more backhaul links (or one or more tunnels). Furthermore, the indication information may also include information about the number of copies. In one embodiment, the number of copies may be an explicit indication information, such as 2, 3, 4, ..., and in another embodiment, the number of copies may be an implicit indication information, for example, the number of copies is indicated by the number of backhaul links (available backhaul links) configured in the above “configuration information related to backhaul links”; and furthermore, combining this information with the above-mentioned “configuration information related to backhaul link” may indicate that the duplicated data packets are to be transmitted by the configured backhaul links (available backhaul links) respectively. As an example, the name of the IE carrying this information may be Additional UP Duplication Indication or other names.

The above-mentioned information related to the tunnel may be related to the uplink tunnel, or may be related to the downlink tunnel. For an uplink tunnel, the above-mentioned “node where one end of the tunnel is located” may be a base station, a central unit of a base station, a user plane part of a central unit of a base station, an anchor node, a central unit of an anchor node, and a user plane part of a central unit of an anchor node. For a downlink tunnel, the above-mentioned “node where one end of the tunnel is located” may be a distributed unit of a base station, a distributed unit of an anchor node, a relay node, or a distributed unit function of a relay node.

### First Aspect: Configuration of User Data Transmission on Base Station Side

This process involves two nodes, namely a first node and a second node, and the type of the two nodes may be any of the above-mentioned node types. Hereinafter, description is made by way of an example of the first node being the central unit of the anchor node, and the second node being the distributed unit of the anchor node, or the relay node, or the distributed unit function of the relay node.

As shown in FIG. 7, the process comprises the following steps:

Step 701: the first node transmits a first resource configuration request message to the second node, the message is used for the second node to perform resource configuration, and the message comprises at least one of the following information:
First configuration information related to a radio bearer, the radio bearer is one or more radio bearers served by the second node; in one embodiment, the radio bearer is the radio bearer of the user equipment accessing the second node, namely the radio bearer served by the access link of the second node (when the second node is a relay node, the access link is a link served by the distributed unit function of the relay node). For a radio bearer, the configuration information comprises at least one of the following information:
   > Identification information of radio bearer, such as DRB ID
   > First information related to tunnel of radio bearer. This information may include related information of one or more tunnels on the first node side. For a tunnel, information included in this information may refer to the above “information related to tunnel”
   > Information related to access link. The access link is a link used by the user equipment to access the second node or the distributed unit part of the second node. This information is used to help the second node generate configuration information of the access link serving the radio bearer, and the information comprises at least one of the following information:
      >> First indication information of data packet duplication, which is used to indicate whether the data packets transmitted on the access link side need to be duplicated and/or the number of copies to be duplicated into. In one embodiment, the information may be used to indicate the duplication of uplink data of the radio bearer; in another embodiment, the information may be used to indicate the duplication of the downlink data of the radio bearer; and in another embodiment, the information may be used to indicate the duplication of the uplink and downlink data of the radio bearer. As an example, the name of the IE carrying this information in the first resource configuration request message may be Additional UP Duplication Indication) or may be other names. This information comprises at least one of the following information:
      >>> First indication information for configuring a duplication function. This information indicates whether the radio bearer is configured with the duplication function of user data packets on the access link side, such as “duplication function configured”, “duplication function not configured.”
      >>> First information related to number of copies to be duplicated into. This information indicates the number of copies that a data packet of the radio bearer is duplicated on the access link side, such as 2, 3, 4.... This information may be explicit information, that is, the number of copies to be duplicated is directly given; and this information may also be implicit information, that is, it is implicitly obtained through other information. In one embodiment, it is indicated by the number of the tunnels (or available tunnels) configured in the above-mentioned “information related to tunnel of radio bearer.” In another embodiment, it is indicated by the number of the backhaul links (or available backhaul links) configured in the above-mentioned “information related to tunnel of radio bearer.”
      >>> Information of a number of RLC entities. This information indicates the number of RLC entities that need to be generated by the second node to serve the radio bearer, such as 2, 3, 4, ..., and furthermore, this information may also be used to indicate the number of copies that a data packet of the radio bearer is to be duplicated into.
      >>> Information of a number of logical channels. This information indicates the number of logical channels that the second node needs to generate to serve the radio bearer, such as 2, 3, 4, .... Furthermore, this information may also be used to indicate the number of copies that a data packet of the radio bearer is to be duplicated into.
      >>> Information of a number of paths (Paths/Legs). This information indicates the number of paths that need to be established to serve the radio bearer, such as 2, 3, 4, .... Each of the paths is used to transmit one of duplicated multiple data packets; and furthermore, this information may also be used to indicate the number of copies that a data packet of the radio bearer is to be duplicated into.
      >>> Information of a number of access link channels. This information indicates the number of access link channels serving the radio bearers, such as 2, 3, 4,....

The function of one or more of the above information is to help the second node generate configuration information related to the radio bearer on the access link side (such as generate the configuration of the RLC entities, generate the configuration of the logical channels, where the number of RLC entities and/or the number of logical channels is the same as the number of the duplicated data packets indicated in the above information). This configuration information is used to transmit the data packets of radio bearer of the user equipment on the access link of the second node. Another function is to help the second node duplicate the data packets of the radio bearer. For example, when the second node receives a data packet, it may determine the number of copies duplicated from the received data packet according to one or more of the above information (If the above information of number indicates 4, then the received data packet is duplicated into four copies), and transmit these duplicated data packets on the access link of the second node. In one implementation, the second node receives a downlink data packet from other nodes, and duplicates the data packet into a corresponding number according to the above information, and then transmit them to the user equipment.
Information related to backhaul link. This information indicates information related to backhaul link serving the radio bearer. This information is used to help the second node decide how to transmit the data of the radio bearer through the backhaul link. The information comprises at least one of the following information:
   > Second indication information of data packet duplication. This information is used to indicate whether a data packet transmitted on the backhaul link side needs to be duplicated and/or the number that a data packet transmitted on the backhaul link side needs to be duplicated into. This information comprises at least one of the following information:
      >> Second indication information for configuring a duplication function. This information indicates whether the duplication function of a user data packet is configured on the backhaul link side, such as “duplication function configured”, “duplication function not configured.” In one embodiment, the indication information indicates duplication of a data packet, wherein the number of copies to be duplicated into is the number of configured backhaul links, that is, the number of all backhaul links configured in the above “information related to tunnel of radio bearer,” wherein each of the copies is transmitted through a separate backhaul link. In another embodiment, the indication information indicates duplication of a data packet on a tunnel, wherein the number of copies to be duplicated into is equal to the number of backhaul links configured for the tunnel, and furthermore, as an example, the indication information may be included in the “information related to tunnel of radio bearer” for a tunnel (that is, the “Indication information of duplication of data packet” in the above-mentioned “information related to tunnel”).
      >> Second information related to number of copies to be duplicated into. This information indicates the number of copies that a data packet of the radio bearer is duplicated into on the backhaul link side, such as 2, 3, 4,... The information may be explicit information, that is, the number of copies to be duplicated into is directly given; and this information may also be implicit information, that is, it is implicitly obtained through other information. In one embodiment, it is indicated by the number of the tunnels (or available tunnels) configured in the above-mentioned “information related to tunnel of radio bearer.” In another embodiment, it is indicated by the number of the backhaul links (or available backhaul links) configured in the above-mentioned “information related to tunnel of radio bearer.” In another embodiment, for a radio bearer tunnel, if multiple backhaul links are configured in the above “information related to tunnel of radio bearer” (that is, a tunnel is configured with multiple backhaul links), it is implicitly indicated that the data on the tunnel needs to be duplicated into multiple copies, wherein the number of copies is the number of configured backhaul links. In this way, the number of copies that data on a tunnel is to be duplicated into may also be determined.
Mapping relationship information. This information indicates the mapping relationship between the backhaul link and the access link channel. This information is used to help the second node decide how to transmit the data packet received on the backhaul link to the access link channel or how to transmit the data packet received on the access link channel to the backhaul link. The information comprises at least one of the following information:
   > Indication information of access link channel. The indication information is used to indicate one or more access link channels. For one access link channel, this information comprises at least one of the following information:
      >> Information related to tunnel. For the content of this information, please refer to the above “information related to tunnel.” In one embodiment, the tunnel is used to serve the data on the access link channel.
      >> Identification information of RLC entity. In one embodiment, the RLC entity is used to serve the access link channel.
      >> Identification information of logical channel. In one embodiment, the logical channel is used to serve the access link channel.
      >> Path identification information corresponding to access link channel, where the path is a path serving the access link channel, and the path is used to transmit a copy of the duplicated data packet.
      >> Other identification information. This information is used to identify an access link channel.
   > Indication information of Backhaul link. This indication information is used to indicate one or more backhaul links corresponding to the access link channel. For a backhaul link, the information comprises at least one of the following information:
      >> Routing identification information contained in data packet on backhaul link. In one embodiment, this identification information may be information contained in the downlink data packet; and in another embodiment, this identification information may be information contained in the uplink data packet. This information comprises address information of the target receiving node (such as BAP address), and/or path identification information (such as Path ID).
      >> Configuration information of backhaul link, for which please refer to the above “Configuration Information related to Backhaul Link” .

Another implicit indication method is that when configuration information of multiple backhaul links in contained in the tunnel configuration information corresponding to the access link channel, backhaul links corresponding to the access link channel are the multiple backhaul links.

The above-mentioned mapping relationship information may implement the following two possible mapping modes:

Mapping mode 1: Multiple backhaul links are mapped to one access link channel. That is, a data packet on one access link channel is transmitted by multiple backhaul links (for example, an uplink data packet on one access link channel is transmitted by multiple backhaul links, or downlink data packets on multiple backhaul links are transmitted by the same access link channel). In one embodiment, the data packet is duplicated and then transmitted by multiple backhaul links.

Mapping mode 2: One backhaul link is mapped to multiple access link channels. That is, a data packet on a backhaul link is transmitted by multiple access link channels (for example, a downlink data packet on a backhaul link is transmitted by multiple access link channels, or data packets on multiple access link channels are transmitted by a backhaul link). In one embodiment, a data packet is duplicated and then transmitted by multiple access link channels.

- First configuration information related to backhaul link channel, which is one or more backhaul link channels served by the second node, and a channel(s) used in serving other nodes (such as other relay nodes) accessing the second node. In one implementation, when the second node is a relay node, the backhaul link channel is a channel served by the distributed unit function of the relay node. One of the functions of the first configuration information is that when the second node receives this information, it generates configuration information related to the backhaul link channel. In one implementation, the second node configures different serving cells for different backhaul link channels, wherein the different backhaul link channels may be backhaul link channels associated with each other. The configuration information comprises at least one of the following information:

> Information of backhaul link channel group. This information is used to indicate backhaul link channels that are associated with each other. In one embodiment, the backhaul link channels that are associated with each other jointly serve the same user equipment. In another implementation, the backhaul link channels that are associated with each other are of one type of data (such as a radio bearer, a data radio bearer DRB, or a signaling radio bearer SRB) that jointly serves a user equipment. In another implementation, when a radio bearer of a user equipment is configured as a bearer that supports duplication function, the backhaul link channels that are associated with each other jointly serve the radio bearer. In another implementation, when a radio bearer of a user equipment is configured as a bearer that supports duplication function, the backhaul link channels that are associated with each other jointly serve the radio bearer, and a backhaul link channel is used to serve a copy of the radio bearer (for example, serve data on a tunnel of the radio bearer). This information may comprise information of one or more backhaul link channels that are associated with each other. For a backhaul link channel, this information comprises at least one of the following information:
>> Identification information of backhaul link channel (such as BH RLC Channel ID)
>> Index information of backhaul link channel (such as BH RLC Channel Index). In one implementation, the index information indicates a backhaul link channel, and the indicated backhaul link channel also has identification information.
   > Configuration information of backhaul link channel. This information comprises configuration information of one or more backhaul link channels. For a backhaul link channel, the information comprises at least one of the following information:
>> Identification information of backhaul link channel
>> Information associated with backhaul link channel. This information is used to inform the second node that the configured backhaul link channel is associated with other backhaul link channels, and further the second node may generate configuration information of the backhaul link channel based on this information. The other backhaul link channels may be one or more. “The configured backhaul link channel is associated with other backhaul link channels” may comprise following possible implementations. One implementation is that the configured backhaul link channel and other backhaul link channels jointly serve the same user equipment. In another implementation, the configured backhaul link channel and other backhaul link channels jointly serve one type of data of a user equipment (for example, a radio bearer, a data radio bearer DRB, or a signaling radio bearer SRB). Another implementation is that when a radio bearer of a user equipment is configured as a bearer that supports duplication function, the configured backhaul link channel and other backhaul link channels jointly serve the radio bearer. Yet another implementation is that when a radio bearer of a user equipment is configured as a bearer that supports duplication function, the configured backhaul link channel and other backhaul link channels jointly serve the radio bearer, and a backhaul link channel is used to serve a copy of the radio bearer (for example, serve data on a tunnel of the radio bearer). The associated information comprises at least one of the following information:
   >>> Index information. The function of the index information is that it may help the second node know other backhaul link channels associated with the configured backhaul link channel. In an implementation, backhaul link channels with the same index information are associated with each other. The index information comprises at least one of the following information:
      >>>> Identification information of the user equipment (such as UE ID). In one implementation, the identification information indicates the user equipment served by the configured backhaul link channel. Furthermore, if the same identification information of the user equipment is also contained when one or more other backhaul links are configured, it is indicated that these backhaul link channels also serve the user equipment.
      >>>> Identification information of radio bearer of the user equipment (such as user equipment identification information and/or identification information of radio bearer, UE DRB ID). In one implementation, the identification information indicates the radio bearer of the user equipment served by the configured backhaul link channel, Furthermore, if the same identification information of radio bearer of the user equipment is also contained when one or more other backhaul links are configured, it is indicated that these backhaul link channels also serve the radio bearer of the user equipment.
      >>>> Association index information (such as Index). In one implementation, if the same association index information is also contained when one or more other backhaul links are configured, it is indicated that these backhaul link channels are associated with the configured backhaul link channel.
      >>>> Group identification information (such as group ID). In one implementation, if the same group identification information is also contained when one or more other backhaul links are configured, it is indicated that these backhaul link channels are associated with the configured backhaul link channel.
      >>>> Identification information of radio bearer that supports duplication function (such as PDCP Duplication Bearer ID). In one implementation, the identification information indicates a radio bearer of the user equipment (the radio bearer support the duplication function) served by the configured backhaul link channel. Furthermore, if the same identification information is also contained when one or more other backhaul link channels are configured, it is indicated that these backhaul link channels also serve the radio bearer of the user equipment.
   >>> Information of associated backhaul link channel (Information of the associated BH RLC Channel). For an associated backhaul link channel, the information comprises at least one of the following information:
      >>>> Identification information of backhaul link channel (such as BH RLC Channel ID)
      >>>> Index information of backhaul link channel (such as BH RLC Channel Index). In one implementation, the index information indicates a backhaul link channel, and the indicated backhaul link channel also has identification information.
>> Associated cell information of backhaul link channel. This information is used to indicate the information of the cell serving the backhaul link channel, and the information comprises at least one of the following information:
   >>> Cell identification information. This information indicates the cell serving the backhaul link channel. Furthermore, if there may be one or more cells serving the backhaul link channel, the cell identification information may comprise identification of the one or more cell.
   >>> Indication information for indicating configuring part of cells to serve the backhaul link channel. The indication information is used to inform the second node to configure only part of the cells to the channel when configuring the cells serving the backhaul link channel.
   >>> Information indicating number of cells serving the backhaul link channel. This information is used to inform the second node to perform configuration according to the number of cells indicated by the information when configuring the cells serving the backhaul link channel.

Step 702 (optional): The second node transmits a first resource configuration response message to the first node, wherein the message contains resource configuration information generated by the second node. The message comprises at least one of the following information:
Second configuration information related to radio bearer, wherein the radio bearer is one or more radio bearers served by the second node. In one implementation, the radio bearer is the radio bearer of the user equipment accessing the second node, that is, the radio bearer served by the access link of the second node (when the second node is a relay node, the access link is a link served by the distributed unit function of the relay node). For a radio bearer, this configuration information comprises at least one of the following information:
   > Identification information of radio bearer, such as DRB ID
   > Second information related to tunnel of radio bearer. This information may comprise information related to one or more tunnels on the second node side. For a tunnel, information included in this information may be found in the above mentioned “Information related to tunnel.”
   > Underlying layer configuration information, please refer to the CellGroupConfig information in TS38.331. This information comprises at least one of the following information:
      >> Configuration information of a RLC entity, wherein the RLC entity is one or more RLC entities serving the radio bearer
      >> Configuration information of a logical channel, wherein the logical channel is one or more logical channels serving the radio bearer
      >> Information of one or more cells serving the above RLC entity or logical channel, such as cell identification information and cell index information
Second configuration information related to backhaul link channel. For a backhaul link channel, the information comprises at least one of the following information (refer to the CellGroupConfig information in TS38.331):
   > Configuration information of a RLC entity, which is an entity that serves the backhaul link channel
   > Configuration information of a logical channel, which is a logical channel that serves the backhaul link channel,
   > Information of one or more cells serving the above RLC entity or logical channel, such as cell identification information, cell index information, etc.

The main function of the above two steps is to help the second node to configure transmission of user data. Furthermore, when the user data needs to be duplicated, the above process helps the second node to configure duplication of the user data. According to the above configuration, in one implementation, the second node only generates the related configuration, but does not duplicate the user data. Whether to perform the duplication or not needs to be based on other configuration information, such as configuration information given in third and fourth aspects of the present disclosure. In another implementation in which the second node performs transmission and duplication of the user data, following steps may also be comprised:

Step 703 (optional)(not depicted in FIG. 7): The second node performs transmission of user data on the radio bearer according to the configuration in steps 701 and 702 above. The possible execution modes are as follows:
For Downlink, the possible actions of the second node comprises at least one of the following:
   > The second node hands over a data packet received from a tunnel to a corresponding access link channel for transmission;
   > The second node hands over a data packet received from a backhaul link to a corresponding access link channel for transmission;
   > The second node duplicates a data packet received from a tunnel into multiple copies (the number of copies to be duplicated may be the number of access link channels configured for the radio bearer, or the number of the access link channels corresponding to the tunnel, or the number of copies that is needed as configured), and then hands over the duplicated data packets to different access link channels for transmission;
   > The second node duplicates a data packet received from a backhaul link into multiple copies (the number of copies to be duplicated may be the number of access link channels configured for the radio bearer, or the number of the access link channels corresponding to the backhaul links, or the number of copies that is needed as configured), and then hands over the duplicated data packets to different access channels for transmission;
   > The second node hands over data packets received from different tunnels (which data packets may contain different routing identification) to the same access link channel for transmission;
   > The second node hands over data packets received from different backhaul links (which data packets may contain different routing identification) to the same access link channel for transmission; and
   > For a data packet, if it is received by the second node through a tunnel or backhaul link, and it is also received by the second node through one or more other tunnels or backhaul links, the second node may drop the data packets repeatedly received.
For Uplink, the possible actions of the second node comprises at least one of the following:
   > The second node hands over a data packet received from an access link channel to a corresponding tunnel for transmission;
   > The second node hands over a data packet received from an access link channel to a corresponding backhaul link for transmission;
   > The second node duplicates a data packet received from an access link channel into multiple copies (the number of copies to be duplicated may be the number of tunnels configured for the radio bearer, or the number of the tunnels corresponding to the access link channel, or the number of copies that is needed as configured), and then hands over the duplicated data packets to different tunnels for transmission;
   > The second node duplicates a data packet received from an access link channels into multiple copies (the number of copies to be duplicated may be the number of backhaul links configured for the radio bearer, or the number of the backhauls link corresponding to the access link channels, or the number of copies that is needed as configured), and then hands over the duplicated data packets to different backhaul links for transmission;
   > The second node hands over data packets received from different access link channels to the same tunnel for transmission;
   > The second node hands over data packets received from different access link channels to the same backhaul link for transmission; and
   > For a data packet, if it is received by the second node through an access link channel, and it is also received by the second node through one or more other access link channels, the second node may drop the data packets repeatedly received.

In order to implement configuration of the number of copies on the access link channel and the backhaul link of the radio bearer, possible implementations are described in combination with specific embodiments. However, it should be noted that the following implementations are only examples and other possible implementations are not excluded.

Embodiment 1: The number of copies of the backhaul link is equal to the number of copies of the access link.

Possible implementations of the above step 701 are as follows:
Mode 1: One tunnel corresponds to one access link channel, and one tunnel corresponds to one backhaul link

This embodiment is the same as the prior art. That is, the second node determines the number of access link channels according to the number of tunnels included in the first resource configuration request message, and the second node does not need to duplicate a data packet; and the second node transmits a data packet received from a tunnel (backhaul link) to corresponding access link channel, or transmits a data packet received from the access link channel through the corresponding tunnel (backhaul link).
Mode 2: One backhaul link corresponds to one access link channel, and the number of tunnels is less than the number of backhaul links.

In this mode, for a tunnel, one or more backhaul links are configured in the message of step 701. In order to indicate to the second node the number of access link channels that need to be established, “Indication information of duplication of data packet” may be included in this information. After the second node receives the information, in one embodiment, the number of access link channels may be determined according to the number of backhaul links configured in this information; and in another embodiment, the number of access link channels corresponding to a tunnel may be determined according to the number of backhaul links configured for the tunnel.

In another implementation of this mode, for a tunnel, the information contains one or more routing identification information, and the number of access channels is determined according to the number of routing identifications contained in this information. In another embodiment, the number of access link channels corresponding to a tunnel may be determined according to the number of routing identifications configured for the tunnel.

Embodiment 2: The number of copies of the backhaul link is greater than the number of copies of the access link.

Possible implementations are as follows:

Mode 1: The number of copies on the backhaul link is determined according to the number of configured tunnels, and the number of the access link channel is determined according to the number of available tunnels configured.

In this mode, the “first information related to tunnel of radio bearer” may be included in the above step 701. The number of available tunnels configured in this information is equal to the number of access link channels, but the number of tunnels included in this information is the number of copies on the backhaul link.

Mode 2: The number of access link channels is determined according to the number of configured tunnels, and the number of copies of the backhaul link is determined according to the number of configured backhaul links.

In this mode, the number of access link channels may be determined according to the number of tunnels configured in the “first information related to tunnel of radio bearer” included in the above step 701. For a tunnel, this information may configure multiple backhaul links, wherein the number of configured backhaul links determines the number of copies of the backhaul link. In another implementation, the number of copies of backhaul link is determined from “Information related to backhaul link that serves the radio bearer” included in step 701.

Embodiment 3: The number of copies of the backhaul link is less than the number of copies of the access link.

The possible implementations are as follows:
Mode 1: The number of access link channels is determined according to the number of configured tunnels, but the number of copies on backhaul link may be determined according to available tunnels.

In this mode, “first information related to tunnel of radio bearer” may be included in the above step 701, wherein the number of tunnels configured in this information is equal to the number of access link channels, but unavailable tunnels (that is, tunnels that do not need to be used on the backhaul link) are determined by including “Indication information of using tunnel” in this information.
Mode 2: The number of the access link channels is determined according to the number of copies on the access link configured.

In this mode, “first information related to tunnel of radio bearer” may be included in the above step 701. For a tunnel, the number of copies that a data packet on the tunnel is to be duplicated into is determined by including “Indication information of duplication of data packet” in this information. In another implementation, the number of the access link channels is determined by including “Information related to access link serving the radio bearer” in step 701.

In the above process, the first resource configuration request message and the first resource configuration response message may be UE Context Setup/Modification Request message and UE Context Setup/Modification Response message of the existing F1 interface, respectively. Alternatively, it may also be a RRC message or other messages.

The beneficial effects of the above steps are:
1) Helping the nodes generate configurations that support data packet duplication, which may have configurations for the access link;
2) Helping the nodes generate configurations of the backhaul link channels they serve, to support the data packet duplication function;
3) Supporting the duplication of data packets on the access link; and
4) Supporting the duplication of data packets on the backhaul link (such as the backhaul link served by the mobile terminal part of the node, or the backhaul link served by the distributed unit part of the node).

### Second Aspect: Configuration of User Data Transmission on Central Unit Side of base station

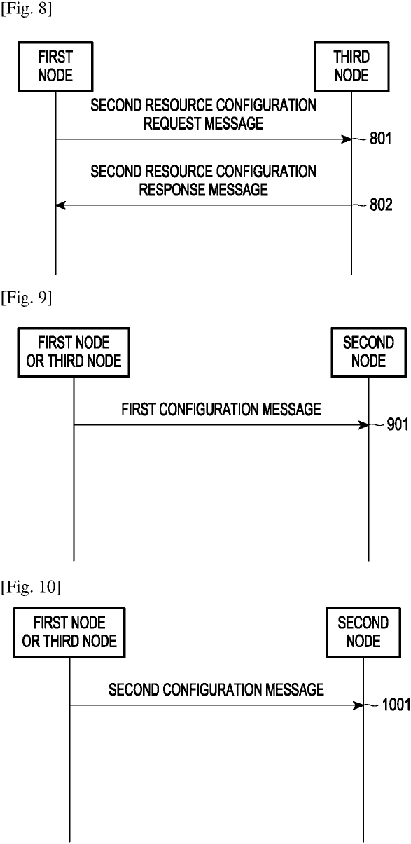

This process involves two nodes, the first node and a third node, and the type of the two nodes may be any of the above-mentioned node types. In an implementation, the first node is the control plane part of the central unit of the anchor node, and the third node is the user plane part of the central unit of the anchor node. This interaction process is used to help the third node determine the number of copies to be duplicated into when transmitting downlink data. As shown in FIG. 8, the process comprises the following steps:

Step 801: The first node transmits a second resource configuration request message to the third node, wherein the message is used to notify the third node of configuration information about downlink data transmission, and the message comprises at least one of the following information:
Identification information of radio bearer, such as DRB ID
Information related to tunnel of radio bearer. In one embodiment, the tunnel is used to serve the downlink data of the radio bearer. There may be one or more tunnels serving the radio bearer. For a tunnel, this information comprises at least one of the following information:
   > IP address. In one embodiment, the IP address is the address of the second node (such as the distributed unit of the base station, the distributed unit of the anchor node, and the distributed unit function of the relay node) serving the radio bearer;
   > Information of Tunnel endpoint identifier of data TEID (such as GTP-TEID (GTP Tunnel Endpoint Identifier)), wherein the TEID is TEID of the node side where one end of the tunnel is located;
   > Indication information of using tunnel. This information is used to indicate whether the tunnel is used to transmit user data, for example, “to use (activate) the tunnel”, in which case the third node may use the tunnel to transmit user data; and for another example, “not to use (deactivate) this tunnel”, in which case the third node does not use this tunnel to transmit user data; and
   > One or more pieces of QoS mapping information (such as the QoS Mapping Information IE in TS38.463). This information is used to help the third node transmit the data packet of the radio bearer. In one embodiment, the third node may set some fields in the transmitted IP packet according to this information. Furthermore, if other nodes receive the IP packet, they may determine how to transmit the IP packet, such as to which node it is transmitted to, using which channel to transmit it, etc. The mapping information may comprise one or more, and for one of them, the information comprises at least one of the following information:
      >> Setting value of Differentiated Services Code Point (DSCP), wherein the DSCP is a field in the IP packet, and this information is used to indicate the setting value of the DSCP field in the IP packet.
      >> Setting value of flow label, wherein the flow label is a field in the IP packet, and this information is used to indicate the setting value of the flow label field in the IP packet.
      >> Indication information of use. This information is used to indicate whether the above QoS mapping information may be used (activated), such as “to use (activate)”, “not to use (deactivate).”

In the prior art, for one tunnel, there is only one set of QoS mapping information. However, in the present disclosure, it is allowed to realize configuration of multiple QoS mapping information for one tunnel. In the actual system, in order to configure multiple QoS mapping information, one possible approach is to introduce a new IE based on the existing QoS Mapping Information IE defined in TS38.463, such as the additional QoS Mapping Information IE, wherein this IE comprises one or more additional QoS mapping information.
> Information related to duplication of data packet. This information is used to configure the third node to duplicate the user data packet. In one embodiment, the user data packet is a user data packet served by the radio bearer, and the information comprises at least one of the following information:
   >> Indication information of configuring duplication of user data packet. This indication information is used to notify the third node to perform user data packet duplication. In one embodiment, the information is to notify the third node to duplicate the data packet on the tunnel. The information may be explicit indication information or implicit indication information. For example, the above-mentioned multiple QoS mapping information implicitly indicate that a data packet needs to be duplicated multiple copies (for example, the number of copies is the number of the QoS mapping information as configured above), wherein the IP header of each data packet needs to be set according to the corresponding QoS mapping information.
   >> Indication information of configuring number of copies of data packet to be duplicated into. This indication information is used to inform the third node of the number of copies of the user data packet to be duplicated into. In one embodiment, this information is to inform the third node of the number of copies that the data packet on the tunnel is to be duplicated into. The information may be explicit indication information, or it may be implicit indication information. For example, the number of QoS mapping information contained implicitly indicates the number of copies that a data packet need to be duplicated into, and the IP header of each data packet needs to be set according to the corresponding QoS mapping information.

Step 802(optional): The third node transmits a second resource configuration response message to the first node. The message is used to confirm the configuration requested in step 701 and provide configuration information generated at the third node, such as information related to tunnel at the third node.

The main function of the above two steps is to help the third node configure transmission of user data. Furthermore, when the user data needs to be duplicated, the above process helps the third node configure duplication of the user data. According to the above configuration, in one implementation, the third node only generates the relevant configuration, but does not duplicate the user data. Whether to perform the duplication is based on other configuration information, such as configuration information given in third and fourth aspects of the present disclosure. In another implementation, the third node performs transmission and duplication of the user data, in which case the following steps may be further included:

Step 803(not depicted in FIG. 8): The third node transmits user data according to the configuration of the messages in steps 801 and 802, which may be performed in the following modes:
Mode 1: If a radio bearer is configured with multiple tunnels (available tunnels), the third node determines the number of copies to be duplicated into according to the number of tunnels (available tunnels), and each copy is transmitted by a tunnel.
Mode 2: If a tunnel of a radio bearer is configured with multiple QoS mapping information, the third node determines the number of copies to be duplicated into according to the number of QoS mapping information (or QoS mapping information that may be used). Each copy sets the fields in the IP packet according to one piece of QoS mapping information.

The above modes are only examples, and other possible modes are not excluded.

In the above process, the second resource configuration request message and the second resource configuration response message may be Bearer Context Setup/Modification Request message and Bearer Context Setup/Modification Response message of the existing E1 interface, respectively, or may be other messages.

The beneficial effects of the above steps are:
1) Helping the nodes generate a configuration that supports data packet duplication; and
2) Implementing transmission of a data packet by the nodes, such as duplicating a user data packet and then performing transmission thereof.

### Third Aspect: Activation and Deactivation of Downlink Data Packet duplication

In the prior art, if transmission of user data is configured with a duplication feature, when transmitting downlink data, the central unit of the base station or the user plane part of the central unit of the base station decides, of its own accord, whether to duplicate the user data. In the present disclosure, considering that the transmission of user data may pass through multiple nodes (such as transmission in a relay network), the duplications of downlink data performed on the backhaul link (the link between the central unit of the anchor node or the distributed unit of the anchor and an access node of the user equipment or distributed unit part of the access node) and the access link may differ from each other. In order to support such features, the present disclosure proposes a variety of new methods for activating or deactivating downlink data duplication.

The nodes involved in this aspect include a first node, a second node and a third node, and the types of the three nodes may be any of the above-mentioned node types. In an implementation, the first node is the central unit of the anchor node or the control plane part of the central unit of the anchor node, the second node is the relay node or the distributed unit function of the relay node or the distributed unit of the anchor node, and the third node is the user plane part of the central unit of the anchor node.

### Method 1: Duplication of a Data Packet Is Performed at the Second Node.

As shown in FIG. 9, the method comprises the following steps:

Step 901: The first node or the third node transmits a first configuration message to the second node, wherein the message is used to help the second node determine a transmission method of user data on the access link, and the message comprises at least one of the following information:
Indication information of duplication of data. This information is used to notify the second node to perform duplication of user data, whose results are then transmitted to the user equipment through the second node.
Indication information of a number of copies that data is to be duplicated into. This indication information is used to notify the second node of a number of copies that user data is to be duplicated into, and this information comprises at least one of the following information:
   > Number of copies that user data is to be duplicated into, such as 2, 3, 4,...
   > Information related to duplicated data. This information indicates the characteristics of the duplicated data, and this information comprises at least one of the following information:
      >> Information related to tunnel to which data belongs. That is, data on the tunnel is to be duplicated. For the content contained in this information, please refer to the above mentioned “Information related to tunnel.”
      >> Information of routing identification (BAP Routing ID) to which data belongs. This information comprises address information of the target receiving node (such as BAP address) and/or path identification information (such as Path ID). That is, a data packet containing the BAP Routing ID is to be duplicated.
Indication information of access link channel. This information is used to indicate which access link channels are used to transmit the duplicated data packets, and the information comprises at least one of the following information:
   > Indication information of activated access link channel. This information indicates access link channels used for transmitting user data packets. For an activated access link channel, the information comprises at least one of the following information:
      >> Identification information of RLC entity;
      >> Indication information of corresponding tunnel. For the content contained in this information, please refer to the above-mentioned “Information related to tunnel”;
      >> Identification information of logical channel;
      >> Path identification information corresponding to access link channel; and
      >> Other identification information, which may identify an access link channel.
   > Indication information of deactivated access link channel. This information indicates access link channels that are not used for transmitting user data packets. For a deactivated access link channel, this information comprises at least one of the following information:
      >> Identification information of RLC entity;
      >> Indication information of corresponding tunnel. For the content contained in this information, please refer to the above-mentioned “Information related to tunnel”;
      >> Identification information of logical channel;
      >> Path identification information corresponding to access channel; and
      >> Other identification information, which may identify an access link channel.
   > Access link channel activation status indication information. This information is used to indicate activation and deactivation status of a group of access link channels. In one possible implementation, a bitmap is defined, wherein each bit in the order from left to right of the bitmap represents an access link channel (for example, the bitmap represents access link channels corresponding to logical channel identifications in ascending order; taking a 3-bit bitmap for example, the three bits represent three access link channels corresponding to logical channels 1, 3, and 7 respectively). The setting value of each bit represents whether the corresponding access link channel is activated or deactivated, for example, “1” represents being activated, while “0” represents being deactivated; or “1” means being deactivated, while “0” means being activated. In another possible implementation, a bitmap is defined, wherein each bit represents a tunnel (or a RLC entity corresponding to the tunnel, or a logical channel corresponding to the tunnel), and the setting value of each bit represents whether one or more access link channels corresponding to the tunnel are activated or deactivated, such as “1” for being activated, and “0” for being deactivated; or “1” for being deactivated, and “0” for being activated.

After receiving the above-mentioned first configuration message, the second node performs duplication and transmission of the user data according to the configuration information in the messages. The above-mentioned first configuration message may be a control plane message or a user plane message. If it is a user plane message, it may be transmitted using the existing TRANSFER USER DATA message in TS38.425, or it may be transmitted with other messages.

### Method 2: Duplication of a Data Packet Is Performed at the Third Node

In this method, the third node, of its own accord, duplicates the data packets, which are then transmitted by the corresponding downlink tunnels or by different routes serving the downlink tunnels. The third node may perform duplication of user data according to the configuration performed in the second aspect of the present disclosure. In one embodiment, if a radio bearer of the user equipment is configured with multiple downlink tunnels, the third node determines to duplicate a data packet of the radio bearer of the user equipment into multiple copies, and then hands them over to different downlink tunnels for transmission, wherein the number of copies to be duplicated into is the number of downlink tunnels configured for the radio bearer. In another embodiment, if a downlink tunnel of a radio bearer of the user equipment is configured with multiple QoS mapping information (see the second aspect of the present disclosure for details), the third node duplicates a data packet of the radio bearer of the user equipment into multiple copies, each setting the relevant field of the data packet according to one of the QoS mapping information, and then transmit them. The number of copies that the data packet is to be duplicated into is the number of configured QoS mapping information.

Beneficial effect of the above steps is:

1) Duplicating and transmitting user data packet(s) by the nodes, wherein the transmitting may be performed on the access links.

### Fourth Aspect: Activation and Deactivation of Duplication of Uplink Data packet

According to the existing mechanisms, on an access link, activation and deactivation of uplink data packet duplication is controlled by the distributed unit serving the access link. In a multi-hop network, an uplink data packet transmitted by the access link may need to be transmitted by an uplink backhaul link, and thus is eventually transmitted to the anchor node. Therefore, different from the existing mechanisms, in a multi-hop network, it is also necessary to determine how to activate and deactivate duplication of an uplink data packet on the backhaul link. In order to support such features, the present disclosure proposes a variety of new methods for activating or deactivating duplication of uplink data.

The nodes involved in this aspect include a first node, a second node and a third node, and the types of the three nodes may be any of the above-mentioned node types. In an implementation, the first node is the central unit of the anchor node or the control plane part of the central unit of the anchor node, the second node is the relay node or the distributed unit function of the relay node or the distributed unit of the anchor node, and the third node is the user plane part of the central unit of the anchor node.

Method 1: The first node or the third node transmits a second configuration message to the second node.

As shown in FIG. 10, the method comprises the following steps:

Step 1001: The first node or the third node transmits a second configuration message to the second node, wherein the message is used to help the second node determine a transmission method of user data on the backhaul link, and the message comprises at least one of the following information:
Indication information of duplication of data. This indication information is used to notify the second node to perform duplication of user data, whose results are then transmitted by the backhaul link;
Indication information of a number of copies that data is to be duplicated into. This indication information is used to notify the second node of a number of copies that user data is to be duplicated into, and this information comprises at least one of the following information:
   > Number of copies that user data is to be duplicated into, such as 2, 3, 4,...
   > Information related to duplicated data. This information indicates the characteristics of the duplicated data, and this information comprises at least one of the following information:
      >> Information related to tunnel to which data belongs. That is, data on the tunnel is to be duplicated. For the content contained in this information, please refer to the above mentioned “Information related to tunnel.”
      >> Information of routing identification (BAP Routing ID) to which data belongs. This information comprises address information of the target receiving node (such as BAP address) and/or path identification information (such as Path ID). That is, a data packet containing the BAP Routing ID is to be duplicated.
   > Indication information of backhaul link. This information is used to indicate which backhaul links are used to transmit the duplicated data packets. This information comprises at least one of the following information:
      >> Indication information of activated backhaul link. This information indicates backhaul links used to transmit user data packets. For an activated backhaul link, the information comprises at least one of the following information:
         >>> Identification information of corresponding RLC entity;
         >>> Indication information of corresponding tunnel. For the content contained in this information, please refer to the above-mentioned “Information related to tunnel”
         >>> Identification information of corresponding logical channel;
         >>> Corresponding path identification information; and
         >>> Other identification information, which may identify a backhaul link.
      >> Indication information of deactivated backhaul link. This information indicates backhaul links that are not used for transmitting user data packets. For a deactivated backhaul link, the information comprises at least one of the following information:
         >>> Identification information of corresponding RLC entity;
         >>> Indication information of corresponding tunnel. For the content contained in this information, please refer to the above-mentioned “Information related to tunnel”;
         >>> Identification information of corresponding logical channel;
         >>> Corresponding path identification information; and
         >>> Other identification information, which may identify a backhaul link.
      >> Backhaul link activation status indication information. This information is used to indicate activation and deactivation status of a group of backhaul links. In one possible implementation, a bitmap is defined, wherein each bit represents a backhaul link or routing identification (BAP routing ID) corresponding to a backhaul link. The setting value of each bit represents whether the corresponding backhaul link channel is activated or deactivated, such as “1” for being activated, and “0” for being deactivated; or “1” for being deactivated, and “0” for being activated. In another possible implementation, a bitmap is defined, wherein each bit represents a tunnel (or a RLC entity corresponding to the tunnel, or a logical channel corresponding to the tunnel), and the setting value of each bit represents whether one or more backhaul links corresponding to the tunnel are activated or deactivated, such as “1” for being activated, and “0” for being deactivated; or “1” for being deactivated, and “0” for being activated.

After receiving the above-mentioned second configuration message, the second node performs duplication and transmission of the user data according to the configuration information in the messages (for example, a data packet received from an access link channel is duplicated and transmitted on respective backhaul links). The above-mentioned second configuration message may be a control plane message or a user plane message. If it is a user plane message, it may be transmitted using the existing TRANSFER USER DATA message in TS38.425, or it may be transmitted with other messages.

### Method 2: The First Node or the Third Node Transmits Configuration information to the second node to determine duplication of user data packet on the backhaul link.

In this method, the configuration information may refer to the configuration process of the first aspect of the present disclosure. If the configuration information configures the mapping relationships between the access link channels and the backhaul links, the data packets transmitted on the activated access link channels need to be transmitted on the corresponding backhaul links. If a data packet on an access link channel corresponds to multiple backhaul links, the second node needs to duplicate the data packet and then transmit them through the corresponding multiple backhaul links. If data packets on multiple access link channels correspond to the same backhaul link, in one embodiment, it is sufficient that the second node hands over a data packet received from one of the access link channels to the respective backhaul link for transmission. Furthermore, the other same data packets received from other access link channels may be discarded by the second node. In another embodiment, it is sufficient that the second node hands over all of the data packets received from multiple access link channels to corresponding backhaul link for transmission.

In this method, if the configuration information configures the number of copies that a data packet on the backhaul link is to be duplicated into, the second node duplicates the data packet received from the access link channel, wherein the number of copies to be duplicated into is the number configured, and then, the second node hands over the duplicated data packets for transmission over the backhaul link. In one embodiment, the second node decides the selected backhaul link. In another embodiment, if the configuration information also configures mapping relationships between the access link channels and the backhaul links, the second node transmits data packets according to the mapping relationships.

Beneficial effect of the above steps is:

1) Duplicating and transmitting user data packets by the nodes, wherein the transmitting may be performed on the backhaul link.

### Fifth Aspect: Transmission and Reception of Configuration Request message

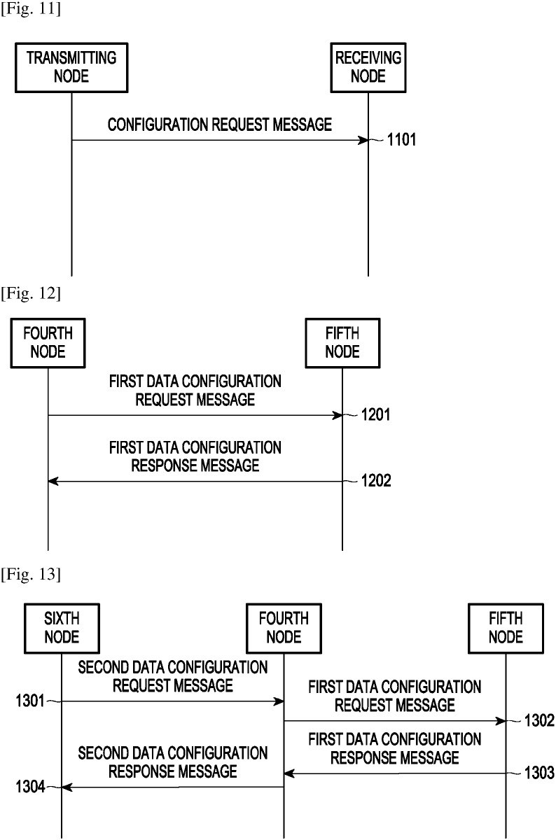

As shown in FIG. 11, a method according to the fifth aspect of the present disclosure comprises the following steps: in step 1101, a transmitting node transmits a configuration request message to a receiving node, wherein the configuration request message comprises a message used by the receiving node to perform configuration of data duplication on a radio bearer. In optional step 1102 (not depicted), the receiving node performs corresponding configuration based on the received message.

The above configuration request message may be at least one of the above first resource configuration request message, the second resource configuration request message, the first configuration message, or the second configuration message.

In an embodiment, the transmitting node may be the first node described above, more specifically, the first node may be a central unit of an anchor node or control plane part of the central unit of the anchor node, and the receiving node may be the second node described above. More specifically, the second node may be a relay node, a distributed unit function of the relay node, or a distributed unit of an anchor node. At this point, the configuration request message may be at least one of the foregoing first resource configuration request message, first configuration message, or second configuration message. In another embodiment, the transmitting node may be the first node described above, more specifically, the first node may be control plane part of a central unit of an anchor node, and the receiving node may be the third node described above. More specifically, the third node may be user plane part of a central unit of an anchor node. At this point, the configuration request message may be the foregoing second resource configuration request message.

In yet another embodiment, the transmitting node may be the third node described above. More specifically, the third node may be user plane part of a central unit of an anchor node, and the receiving node may be the second node described above. More specifically, the second node may be a relay node, a distributed unit function of the relay node, or a distributed unit of an anchor node. At this point, the configuration request message may be at least one of the foregoing first resource configuration request message, first configuration message, or second configuration message.

Based on the five aspects of the present disclosure, beneficial effects achieved by the present disclosure include:
1) Helping the nodes generate configurations that support data packet duplication, and these configurations may have configuration for an access link;
2) Helping the nodes generate configurations of the backhaul link channels they serve, to support data packet duplication function;
3) Supporting duplication of data packets on access links;
4) Supporting duplication of data packets on backhaul links (such as a backhaul link served by mobile terminal part of a node, or a backhaul link served by distributed unit part of a node);
5) Helping the nodes transmit user data packets, such as duplicating user data packets and then transmitting them; and
6) Duplicating and transmitting uplink or downlink data packets by the nodes, wherein the transmitting may performed on access links or on backhaul links.

According to an aspect of the present disclosure, a data transmission method is provided, wherein the method may comprise: receiving by a receiving node a configuration request message from a transmitting node; and performing by the receiving node a data duplication configuration on a radio bearer based on the received configuration request message.

In an embodiment, the configuration request message may be a first resource configuration request message, where the first resource configuration request message may comprise at least one of the following: first configuration information related to the radio bearer; and first configuration information related to a backhaul link channel, for the receiving node to generate configuration information related to the backhaul link channel.

In an embodiment, the first configuration information related to the radio bearer may comprise first information related to a tunnel of the radio bearer, and the first information related to the tunnel of the radio bearer may comprise identification indication information for indicating an access link channel corresponding to the tunnel.

In one embodiment, the method may further comprise: transmitting by the receiving node a first resource configuration response message to the transmitting node, the message comprising resource configuration information generated by the receiving node; and

In an embodiment, the method may further comprise: performing by the receiving node transmission of user data on the radio bearer according to a configuration in at least one of the first resource configuration request message and the resource configuration information generated by the receiving node.

In an embodiment, the first configuration information related to the radio bearer may comprise at least one of the following: identification information of the radio bearer, first information related to the tunnel of the radio bearer, information related to the access link, information related to the backhaul link and mapping relationship information indicating a mapping relationship between the backhaul link and the access link channel.

Furthermore, the above-mentioned information related to the access link may comprise first indication information of data packet duplication. Still furthermore, the first indication information of data packet duplication may comprise at least one of the following: first indication information for configuring a duplication function; first information related to a number of copies to be duplicated into, the first information indicating a number of copies that a data packet of the radio bearer is to be duplicated into on an access link side; information of a number of RLC entities; information of a number of logical channels; information of a number of paths (Paths/Legs); and information of a number of access link channels.

Furthermore, the above-mentioned information related to the backhaul link may comprise second indication information of data packet duplication. Still furthermore, the second indication information of data packet duplication may comprise at least one of the following: second indication information for configuring a duplication function; and second information related to number of copies to be duplicated into, the second information indicating a number of copies that a data packet of the radio bearer is to be duplicated into on a backhaul link side.

The foregoing first configuration information related to the backhaul link channel may comprise at least one of the following: information of a group of backhaul link channels and configuration information of the backhaul link channels.

In an embodiment, the number of backhaul links configured in the first information related to the tunnel of the radio bearer may be used to determine second information related to number of copies to be duplicated into, the second information indicating a number of copies that a data packet of the radio bearer is to be duplicated into on a backhaul link side.

In an embodiment, the transmitting node may be a central unit of an anchor node, and the receiving node may be a distributed unit of the anchor node, or a relay node, or a distributed unit function of the relay node.

In an embodiment, the first resource configuration request message and the first resource configuration response message may be a UE Context Setup/Modification Request message and a UE Context Setup/Modification Response message of the existing F1 interface, respectively, or may be RRC messages.

In an embodiment, the configuration request message is a second resource configuration request message, which is used to notify the receiving node of configuration information about downlink data transmission, wherein the second resource configuration request message comprises at least one of the following: the identification information of the radio bearer and the information related to the tunnel of the radio bearer.

In an embodiment, the information related to the tunnel of the radio bearer may comprise at least one of the following: Internet Protocol (IP) address, tunnel endpoint identifier of data, indication information of use of a tunnel, one or more QoS mapping information and information related to duplication of data.

In an embodiment, the method may further comprise: transmitting by the receiving node a second resource configuration response message to the transmitting node, wherein the second resource configuration response message is used to confirm a configuration requested by the transmitting node and comprises configuration information generated at the receiving node.

In an embodiment, the method may further comprise: transmitting by the receiving node user data according to a configuration in at least one of the second resource configuration request message and the second resource configuration response message.

In an embodiment, the method may further comprise: if a radio bearer is configured with multiple available tunnels according to the information related to the tunnel of the radio bearer, the receiving node determines the number of copies to be duplicated into according to a number of available tunnels, with each copy being transmitted by a tunnel.

In an embodiment, the method may further comprise: if a tunnel of a radio bearer is configured with multiple quality of service (QoS) mapping information according to the information related to the tunnel of the radio bearer, the receiving node may determine the number of copies to be duplicated into according to the number of the QoS mapping information, with each copy setting a field in an IP packet according to a piece of QoS mapping information.

In one embodiment, the transmitting node may be control plane part of a central unit of an anchor node, and the receiving node may be user plane part of the central unit of the anchor node.

In an embodiment, the second resource configuration request message and the second resource configuration response message may be a Bearer Context Setup/Modification Request message and a Bearer Context Setup/Modification Response message of the existing E1 interface, respectively.

In an embodiment, the receiving node further receives a first configuration message from the transmitting node, the message being used to help the receiving node determine a transmission method of user data on the access link.

In an embodiment, the receiving node further receives a second configuration message from the transmitting node, the message helping the receiving node determine a transmission method of user data on the backhaul link.

In an embodiment, the configuration request message may be a first configuration message, and the message may be used to help the receiving node determine a transmission method of user data on the access link, wherein the first configuration message comprises at least one of the following: indication information of duplication of data; and indication information of the number of copies that data is to be duplicated into.

In an embodiment, the method further comprises: after receiving the above-mentioned first configuration message, the receiving node may perform duplication and transmission of user data according to configuration information therein.

In an embodiment, the first configuration message may be a TRANSFER USER DATA message.

In an embodiment, the transmitting node may be a central unit of an anchor node or control plane part of the central unit of the anchor node, and the receiving node may be a relay node, a distributed unit function of the relay node, or a distributed unit of the anchor node.

In another embodiment, the transmitting node may be user plane part of a central unit of an anchor node, and the receiving node may be a relay node or a distributed unit function of the relay node or a distributed unit of the anchor node.

In an embodiment, the configuration request message may be a second configuration message, and the message may be used to help the receiving node determine a transmission method of user data on the backhaul link, wherein the second configuration message comprises at least one the following: indication information of duplication of data; and indication information of the number of copies that data to be duplicated into.

In an embodiment, the method may further comprise: after receiving the above-mentioned second configuration message, the receiving node performs duplication and transmission of user data according to configuration information therein.

In an embodiment, the transmitting node may be a central unit of an anchor node or control plane part of the central unit of the anchor node, and the receiving node may be a relay node or a distributed unit function of the relay node or a distributed unit of the anchor node.

In another embodiment, the transmitting node may be user plane part of a central unit of an anchor node, and the receiving node may be a relay node or a distributed unit function of the relay node or a distributed unit of the anchor node.

In an embodiment, the data duplication of the radio bearer may comprise: duplication of a user data packet of Packet Data Convergence Protocol (PDCP) layer.

According to an aspect of the present disclosure, there is provided a receiving node, which may comprise: a transceiver; and a processor configured to control the transceiver to perform the methods as described above.

In an embodiment, the receiving node may be the second node or the third node described above. More specifically, the second node may be a relay node or a distributed unit function of the relay node or a distributed unit of an anchor node, and the third node may be user plane part of a central unit of the anchor node.

According to an aspect of the present disclosure, there is provided a transmitting node, which may comprise: a transceiver; and a processor configured to: control the transceiver to transmit a configuration request message to a receiving node, for the receiving node to perform configuration of duplication of data of a radio bearer.

In an embodiment, the transmitting node may be the first node or the third node described above. More specifically, the first node may be a central unit of an anchor node or control plane part of the central unit of the anchor node, and the third node may be user plane part of the central unit of the anchor node.

Although one or more embodiments have been described with reference to the accompanying drawings, those of ordinary skill in the art will understand that various changes in forms and details may be made without departing from the spirit and scope defined by the appended claims.

### Sixth Aspect: Control Signaling Segmentation

According to the existing mechanisms, when a control signaling message (such as a RRC message) is transmitted between a base station and a user equipment, if the control signaling message is large, it may be segmented and then transmitted. However, when the content of a control signaling message is generated by multiple nodes, because these nodes do not know sizes of the control signaling message allowed by each other, the information in the control signaling message generated by the nodes may cause the size of the control signaling message to exceed the limit. Therefore, a sixth aspect of the present disclosure provides a method for ensuring that a size of a control signaling message does not exceed a limit among multiple nodes. The nodes involved in this method comprise:
A fourth node: This node is used to transmit a control signaling message (such as a RRC message) to a user equipment, or generate a control signaling message (such as a RRC messages), or generate and transmit a control signaling message (such as a RRC messages), or generate part of information in a control signaling message.
A fifth node: This node is used to generate a control signaling message (such as a RRC messages), or generate part of information in a control signaling message.

In one embodiment, for the Dual Connectivity scenario, the fourth node is a master node (or a central unit of the master node, or control plane part of the central unit of the master node), and the fourth node eventually generates a control signaling message and transmits it to a user; and the fifth node is a secondary node (or a central unit of the secondary node, or control plane part of the central unit of the secondary node), and the fifth node generates part of information in the control signaling message.

In another embodiment, for the handover scenario, the fourth node is a source node (or a central unit of the source node, or control plane part of the central unit of the source node), and transmits a control signaling message to a user; and the fifth node is a target node (or a central unit of the target node, or control plane part of the central unit of the target node), and is a node that generates a control signaling message.

In another embodiment, for a base station with a CU-DU split architecture, the fourth node is a central unit of the base station, and the fifth node is a distributed unit of the base station. In one embodiment, the base station may be a base station serving a user equipment in single connectivity. In this case, the fourth node is the node that generates a control signaling message (such as a RRC messages) and transmits the message to the user; and the fifth node is the node that generates part of information in the control signaling message. In another embodiment, the base station may be a secondary base station in dual connectivity. In this case, both the fourth node and the fifth node are nodes that generate part of information of the control signaling message; and the control signaling message may eventually be generated by other nodes (such as the master base station), and transmitted to the user equipment by other nodes (such as the master base station) (furthermore, in one embodiment, the central unit of the master base station and the central unit of the secondary base station are the same node, but the distributed units thereof are two different nodes). In another embodiment, the base station is the target base station in the handover process. In this case, the fourth node is the node that eventually generates the control signaling message, and the fifth node is the node that generates part of information in the control signaling message. The control signaling message is transmitted by other nodes (such as the source base station) to the user equipment (furthermore, in one embodiment, the central unit of the source base station and the central unit of the target base station are the same node, but the distributed units thereof are two different nodes).

This aspect relates to segmentation of a control signaling message, and each segment may be included in another control signaling message. Therefore, for the convenience of description, the present disclosure defines the following descriptions:
A first control signaling message: This message is a message that needs to be segmented, such as a RRC message that needs to be segmented (such as RRCReconfiguration, RRCResume, UECapabilityInformation);
A second control signaling message: This message is a message that contains a segment of the first control signaling message, such as DLDedicatedMessageSegment message and ULDedicatedMessageSegment message.

In addition, in one embodiment, the first or second control signaling messages are a RRC message.

The method of this aspect is not only applicable to single-hop networks, but also applicable to multi-hop networks (such as IAB network).

FIG. 12 is an example of the flow of segmentation of a control signaling message according to the present disclosure.

In order to support the segmentation of the control signaling message, the interaction process between the foregoing fourth node and fifth node comprises following steps:

Step 1201 in FIG. 12 : The fourth node transmits a first data configuration request message to the fifth node, wherein the message is used to notify the fifth node of configuration information required in generating a control signaling message or part of information in the control signaling message. The first data configuration request message comprises at least one of the following information:
First capability information. This information is used to indicate whether a node has a segmentation capability. “a node” here may be a node that generates a control signaling messages (such as a RRC messages), or it may be a node that transmits a control signaling message to a user equipment. In one embodiment, for dual connectivity, if the fourth node is a master node (or a central unit of the master node, or control plane part of the central unit of the master node), then the said “a node” is the fourth node. In another embodiment, for dual connectivity, if the fourth node is a central unit of a secondary node (or control plane part of the central unit of the secondary node), then “a node” here is a master node (or a central unit of the master node, or control plane part of the central unit of the master node). “a node” here may also be considered as a neighbor node of the fourth node. In another embodiment, for handover, if the fourth node is a source node (or a central unit of the source node, or control plane part of the central unit of the source node), then “a node” here is the fourth node. In another embodiment, for handover, if the fourth node is a central unit of a target node (or control plane part of the central unit of the target node), “a node” here is a source node (or a central unit of the source node, or control plane part of the central unit of the source node). In another embodiment, in the case where a user equipment is served by a base station, if the fourth node is the central unit of the base station (or the control plane part of the central unit of the base station), then “a node” here is the fourth node. The first capability information comprises at least one of the following information:
   > Control signaling message segmentation allowed, such as RRC Segmentation allowed;
   > Control signaling message segmentation not allowed, such as RRC Segmentation not allowed;
   > Indication information of segmentation capability, such as RRC Segmentation Capability information, which may indicate “allowed” or “not-allowed”; and
   > Identification information of applicable node, such as identification information of a base station, identification information of a cell, and identification information of a distributed unit. This information indicates nodes to which the above-mentioned “Control signaling message segmentation allowed” or “Control signaling message segmentation not allowed” is applicable. In one embodiment, a node indicated by the this information is the node that generates the first control signaling message or the second control signaling message, or is the node that transmits the first control signaling message or the second control signaling message to the user; and in such a case, the fifth node may determine a size of the generated control information or a size of the generated control signaling message according to this information.
First information indicating a size. This information is used to indicate an allowed size of control information in a control signaling message (such as information in a RRC message, such as CellGroupConfig, MeasGapConfig, CG-Config, CG-ConfigInfo, etc.) when generating the control information. The control information may be used for the fourth node to generate a control signaling messages(such as a RRC message), or may be used for other nodes to generate a control signaling messages (such as a RRC message). In one embodiment, the above-mentioned other nodes may be a master node in dual connectivity (or a central unit of the master node, or control plane part of the central unit of the master node), and the fourth node and the fifth node are secondary nodes. In another embodiment, the above-mentioned other nodes may be secondary nodes in dual connectivity (or central units of the secondary nodes, or control plane part of the central units of the secondary nodes), and the above-mentioned fourth node and the fifth node are master nodes. In another embodiment, the above-mentioned other nodes may be source nodes in the handover process, and the above-mentioned fourth node and the fifth node are target nodes. The first information indicating a size for the control information comprises at least one of the following information:
   > Indication information of an allowed information size. The function of this information is to indicate a number of bits allowed or a number of bytes allowed when the fifth node generates control information in a control signaling message;
   > Indication information of a number of an allowed segments. The function of this information is to indicates a number of segments allowed when the fifth node generates control information in a control signaling message;
   > Indication information of configuration of an allowed information size. This information indicates a size configuration when the fifth node generates control information in the control signaling. The configuration may be pre-configured to the fifth node, such as pre-configured by OAM. After receiving the indication information, the fifth node may determine an allowed size of the generated control information according to the pre-configuration;
   > Identification information of applicable nodes, such as identification information of a base station, identification information of a cell, and identification information of a distributed unit. This information indicates nodes to which above-mentioned “indication information of an allowed information size” or “indication information of a number of allowed segments” or “indication information of configuration of an allowed information size” is applicable. In one embodiment, the node indicated by the information is a node that generates the first control signaling message or the second control signaling message, or a node that transmits the first control signaling message or the second control signaling message to a user; and in such cases, the fifth node may determine a size of the generated control information or a size of the generated control signaling message according to this information; and
   > Indication information of applicable scenarios. The function of this information is to indicate scenarios to which above-mentioned “indication information of an allowed information size” or “indication information of a number of allowed segments” or “indication information of configuration of an allowed information size” is applicable. The scenarios indicated by this information may be one of the following scenarios: the fifth node is a target node in the handover (or a central unit of the target node, or control plane part of the central unit of the target node); the fifth node is a distributed unit of the target node in the handover; the fifth node is a secondary node in the dual connectivity (or a central unit of the secondary node, or control plane part of the central unit of the secondary node); the fifth node is a distributed unit of the secondary node in the dual connectivity; and the fifth node a distributed unit of a base station (furthermore, the base station is the only base station connected by the user).
Second information indicating a size. This information is used to indicate a size of control information reserved in a control signaling message. The reserved control information may be generated by the fourth node or may be generated by other nodes. In one embodiment, the above-mentioned other nodes may be a master node in the dual connectivity (or a central unit of the master node, or control plane part of the central unit of the master node), and the above-mentioned fourth node and the fifth node are secondary nodes. In another embodiment, the above-mentioned other nodes may be secondary nodes in the dual connectivity (or central units of the secondary nodes, or control plane part of the central units of the secondary nodes), and the above-mentioned fourth node and the fifth node are master nodes. In another embodiment, the above-mentioned other nodes may be source nodes in the handover process, and the above-mentioned fourth node and the fifth node are target nodes. The second information indicating a size for the control information comprises at least one of the following information:
   > Size information. The function of this information is to indicate a number of bits or bytes of control information reserved in a control signaling message;
   > Indication information of a number of segments. The function of this information is to indicate the number of segments occupied by control information reserved in a control signaling message; and
   > Indication information of applicable scenarios. The function of this information is to indicate scenarios to which the above-mentioned “size information” or “indication information of a number of segments” is applicable. The scenarios indicated by this information may be one of the following scenarios: the fifth node is a target node in the handover (or a central unit of the target node, or control plane part of the central unit of the target node); the fifth node is a distributed unit of the target node in the handover; the fifth node is a secondary node in the dual connectivity (or a central unit of the secondary node, or control plane part of the central unit of the secondary node); the fifth node is a distributed unit of the secondary node in the dual connectivity; and the fifth node a distributed unit of a base station (furthermore, the base station is the only base station connected by the user equipment).
First signaling information, which contains the first control signaling message and/or the second control signaling message generated by the fourth node. In one embodiment, the first or second control signaling message may be transmitted in the form of a container. When the first control signaling message is segmented, the message may be contained in multiple containers, each container containing a second control signaling message, and each second control signaling message may contain a segment of the first control signaling message. For a container containing a segment of the first control signaling message, the first signaling information comprises at least one of the following:
First control information container, which contains the first or second control signaling message. In one embodiment, for the F1 interface, the control signaling message may be transmitted to the user equipment by the fifth node. Furthermore, the container contains the second control signaling message, and the second control signaling message contains a segment of the first control signaling message. In another embodiment, for the X2/Xn interface, the control signaling message is generated by the fourth node and helps the fifth node generate configuration information. For example, in the case of dual connectivity, the control signaling message is the information contained in the container from the master node to the secondary node; while in the case of handover, the message is the HandoverPreparationInformation message;
Segment numbering information. This information indicates numbering of segments of a first control signaling message contained in the above-mentioned container containing the control signaling message; and
Indication information of the last segment. This indication information indicates whether a segment of a first control signaling message contained in the above-mentioned “container containing a control signaling message” is the last segment, for example, indicating that it is the last segment; or that it is not the last segment.

In order to distinguish from the prior art, the above-mentioned “first signaling information” may contain multiple containers, and each container may contain a second control signaling message that carries a segment of the first control signaling message (such as, a DLDedicatedMessageSegment message containing a segment of RRCReconfiguration/RRCResume message). In the prior art, the fourth node can only transmit a container containing the RRC message to the fifth node. For example, there is only one RRC-Container IE in the F1AP message, which contains only one RRC message. However, in the present disclosure, the above-mentioned “first signaling information” contains multiple containers, and each container contains a RRC message. In one embodiment, in order to continue using the existing signaling design, the fourth node may comprise in the existing RRC-Container IE a RRC message (such as a DLDedicatedMessageSegment message). Furthermore, the RRC message contains a segment of the first control signaling message, and then the above-mentioned “first signaling information” is a newly added IE (such as named as Additional RRC-Container, or Additional RRC-Container List). This IE carries one or more additional RRC-Containers, and this new IE and the segments of the RRC message carried in the existing IE may form a complete first control signaling message.
Second signaling information, which contains control signaling messages generated by other nodes. In one embodiment, the above-mentioned other nodes may be a master node in the the dual connectivity (or a central unit of the master node, or control plane part of the central unit of the master node), and the fourth node and the fifth node are secondary nodes. In another embodiment, the above-mentioned other nodes may be a secondary node in the dual connectivity (or a central unit of secondary node, or control plane part of the central unit of the secondary node), and the above-mentioned fourth node and fifth node are master nodes. In another embodiment, the above-mentioned other nodes may be a source node in the handover process, and the above-mentioned fourth node and fifth node are target nodes. The second signaling information containing the control signaling message comprises at least one of the following:
   > Second control information container, which contains a control signaling message, where the control signaling message may come from other nodes mentioned above. In one embodiment, for the F1 interface, the second control container may be a CU to DU RRC Information element; and for the X2/Xn interface, the second control information container may be a container IE from the master node to the secondary node, or a HandoverPreparationInformation IE or CG-ConfigInfo IE;
   > Node identification information. This information indicates nodes that generate a control signaling message contained in the above second control information container, such as identification information of a base station, identification information of a cell, etc. In one embodiment, after receiving the information, the fifth node may generate control information according to a pre-configured size (such as a size configured by OAM); and
   > Second capability information. This information is used to indicate a segmentation capability of a node (the node may be called a neighbor node) that generates a control signaling message (such as a RRC message) contained in the above-mentioned “second control information container.” In one embodiment, for dual connectivity, the node is a master node or a central unit of the master node, or control plane part of the central unit of the master node. In another embodiment, for handover, the node is a source node, or a central unit of the source node, or control plane part of the central unit of the source node. After receiving the information, the fifth node generates the information in the control signaling message according to this information. The second capability information comprises at least one of the following:
      >> Control signaling message segmentation allowed, such as RRC Segmentation allowed;
      >> Control signaling message segmentation not allowed, such as RRC Segmentation not allowed; and
      >> Indication information of segmentation capability, such as RRC Segmentation Capability information, which may indicate “allowed” or “not-allowed.”

In an embodiment, the aforementioned “second capability information” may also be included in the control signaling message contained in the aforementioned “second control information container”.

Step 1202 in FIG. 12 : Optionally, the fifth node transmits a first data configuration response message to the fourth node, wherein the message is used to transmit to the fourth node part of the information in the control signaling message generated by the fifth node or the control signaling message generated by the fifth node itself, which comprises at least one of the following:
Cause information. The function of this information is to indicate cause information of the information contained in the first data configuration response message, such as a restricted control signaling message size (restricted RRC message size) and a restricted control information size (restricted RRC Information size). Furthermore, the cause information may also be used to indicate the fifth node a cause of generating at least one of the following configurations:
   Establishment of SRB failed
   Establishment of DRB failed
   Increase of PDU session resource not accepted
   Establishment of Cell failed
   Modification of SRB failed
   Modification of DRB failed
   Modification of PDU session resource not accepted

After receiving this information, the fourth node may learn that the cause for the failure is not that the resources of the fifth node are insufficient, so the fourth node may continue requesting the fifth node to establish a SRB, or establish a DRB, or increase PDU session resources, or establish a cell, or modify the SRB, or modify the DRB, or modify the PDU session resources, etc.
First configuration control information. This information is the configuration information generated by the fifth node. The information contained in this configuration information may be contained in the first control signaling message or the second control signaling message and then transmitted to the user equipment. This information may be contained in one or more Information Elements (IE), and the one or more information elements include at least one of the following information:
   > First control information. This information is the information to configure the user equipment generated by the fifth node. In one embodiment, for the F1 interface, this information may be a DU to CU RRC Information element transmitted by a distributed unit to a central unit on the F1 interface or information contained in the information element. In another embodiment, for the signaling interaction related to the dual connectivity on the X2/Xn interface, the information may be a CG-Config information element transmitted by a secondary base station to a master base station or information contained in the information element. In another embodiment, for the signaling exchanges related to handover on the X2/Xn interface, the information may be a HandoverCommand message transmitted by a target node to a source node or information contained in the message.
   > Configuration information corresponding to the above-mentioned “first control information.” This information indicates a configuration with which the fifth node generates the above-mentioned “first control information”, and this information comprises at least one of the following information:
      >> Identification information of SRB, which indicates the SRB configured by the above “first control information” (or the SRB not configured);
      >> Identification information of DRB, which indicates the DRB configured by the above “first control information” (or the DRB not configured);
      >> Identification information of PDU session, which indicates the PDU session configured by the above “first control information” (or the PDU session not configured); and
      >> Identification information of Cell, which indicates the cell configured by the above “first control information” (or the cell not configured).

When the above-mentioned “first configuration control information” comprises a plurality of “first control information”, the “first configuration control information” is different from that in the prior art. Specifically, taking the F1 interface as an example, in the prior art, the message transmitted by the distributed unit to the central unit may contain a DU to CU RRC Information IE. In contrast, in the present disclosure, it is allowed to contain multiple DU to CU RRC Information IEs, which contain all the control information required to configure a user equipment. Accordingly, in addition to the existing DU to CU RRC Information IE, a new IE may also be defined to carry control information that is not contained in the existing “DU to CU RRC Information IE” in the above-mentioned “first control information”. In an embodiment, the new IE may be “Additional DU to CU RRC Information” or “Additional DU to CU RRC Information List” etc. Taking the signaling interactions related to the dual connectivity on the Xn/X2 interface as an example, in the prior art, the message transmitted by a secondary node to a master node may contain a Secondary Node to Master Node container IE (the IE containing CG-Config). In contrast, in the present disclosure, it is allowed to include multiple Secondary Node to Master Node container IEs. These IEs contain all the control information required to configure the user equipment. Accordingly, in addition to the existing Secondary Node to Master Node container IE, a new IE may also be defined to carry control information that is not contained in the existing “Secondary Node to Master node container IE” in the above-mentioned “first control information”. In an embodiment, the new IE may be “Additional Secondary Node to Master Node Container” or “Additional Secondary Node to Master Node Container List” etc.

For different types of the fourth node and the fifth node, there may be several embodiments of the above process as follows. In the following embodiments 12-a to 12-f, detailed descriptions for the information contained in each message may be found in the above steps 1201 and 1202 of FIG. 12.

Embodiment 12-a (Single connectivity scenario, where CU and DU are split, the fourth node is a central unit (CU) of a base station, the fifth node is a distributed unit (DU) of the base station, and a size limit of the control information is set by the CU)

In this embodiment 12-a, the fourth node and the fifth node are the central unit of the base station (or control plane part of the central unit) and the distributed unit of the base station, respectively, and the size limit of the control information generated by the distributed unit is configured by the central unit. This embodiment 12-a may comprise the following processes:

Step 12-a-1201: The fourth node transmits a first data configuration request message to the fifth node, wherein the message comprises at least one of the following information:
First capability information;
First information indicating a size; and
Second information indicating a size.

Step 12-a-1202: The fifth node transmits a first data configuration response message to the fourth node, wherein the message comprises at least one of the following information:
Cause information; and
First configuration control information, for which please refer to the descriptions in “First Configuration Control Information” for the F1 interface in the above step 1202 in FIG. 12.

In this embodiment 12-a, the distributed unit of the base station may determine the generated control information according to the information transmitted by the central unit of the base station (such as the size information of the control information), so as to help the central unit of the base station generate a control signaling message of an appropriate size (such as RRCReconfiguration, RRCResume, CG-Config, HandoverCommand, etc.).

Embodiment 12-b (Single connectivity scenario, where CU and DU are split, the fourth node is the central unit of the base station, the fifth node is the distributed unit of the base station, and the size limit of the control information is set by OAM)

In this embodiment 12-b, the information of the size allowed when the distributed unit of the base station generates the control information is configured by the OAM. Therefore, the distributed unit may generate the control information based on this information. This embodiment 12-b may comprise the following processes:

Step 12-b-1201: The fourth node transmits a first data configuration request message to the fifth node, wherein the message comprises at least one of the following information:
First capability information

Step 12-b-1202: The fifth node transmits a first data configuration response message to the fourth node, wherein the message comprises at least one of the following information:
Cause information
First configuration control information, for which please refer to the descriptions in “First Configuration Control Information” for the F1 interface in the above step 1202 in FIG. 12.

In this embodiment 12-b, the distributed unit of the base station may determine the generated control information according to the size information of the control information configured by the OAM, so as to help the central unit of the base station generate a control signaling message of an appropriate size.

In an optional embodiment, the above steps 12-a-1202 and 12-b-1202 may be optional steps.

In the processes of the above embodiments 12-a and 12-b, the first data configuration request message and the first data configuration response message may be non-user equipment-associated F1 messages, such as a GNB-CU Configuration Update and a GNB-CU Configuration Update Acknowledge message, respectively, or may be user equipment-associated F1 messages, such as a UE Context Setup/Modification Request message and a UE Context Setup/Modification Response message, respectively, or may be newly defined messages.

Embodiment 12-c (dual connectivity scenario, where the fourth node is the master node or the central unit of the master node, or the control plane part of the central unit of the master node, and the fifth node is the secondary node, or the central unit of the secondary node, or the control plane part of the central unit of the secondary node, and the size limit of the control information is set by the master node or the central unit of the master node, or the control plane part of the central unit of the master node)

In this embodiment 12-c, the master node may inform the secondary node of information of the size allowed when generating the control information, such that the secondary node generates the control information based on this information. This embodiment 12-c may comprises the following processes:
Step 12-c-1201: The fourth node transmits a first data configuration request message to the fifth node, wherein the message comprises at least one of the following information:
   First capability information, which indicates a capability of the fourth node in one embodiment;
   First information indicating a size;
   Second information indicating a size; and
   Second signaling information.
Step 12-c-1202: The fifth node transmits a first data configuration response message to the fourth node, wherein the message comprises at least one of the following information:
   Cause information; and
   First configuration control information, for which please refer to the descriptions in “First Configuration Control Information” for the X2/Xn interface in the above step 1202 in FIG. 12.

In this embodiment 12-c, the secondary node may determine the generated control information according to the information transmitted by the master node (such as size information of the control information), thereby helping the master node generate a control signaling message of an appropriate size.

Embodiment 12-d (dual connectivity scenario, where the fourth node is the master node or the central unit of the master node, or the control plane part of the central unit of the master node, and the fifth node is the secondary node, or the central unit of the secondary node, or the control plane part of the central unit of the secondary node, and the size limit of the control information is set by OAM)

In this embodiment 12-d, the OAM configures information of the size allowed when generating the control information by the secondary node, such that the secondary node generates control information based on this information. This embodiment 12-d may comprise the following processes:
Step 12-d-1201: The fourth node transmits a first data configuration request message to the fifth node, wherein the message comprises at least one of the following information:
   First capability information; and
   Second signaling information.
Step 12-d-1202: The fifth node transmits a first data configuration response message to the fourth node, wherein the message comprises at least one of the following information:
   Cause information; and
   First configuration control information, for which please refer to the descriptions in “First Configuration Control Information” for the X2/Xn interface in the above step 1202 in FIG. 12.

In this embodiment 12-d, the secondary node may determine the size of the generated control information according to the configuration by the OAM, so as to help the master node generate a control signaling message of an appropriate size.

In an optional embodiment, the above steps 12-c-1202 and 12-d-1202 may be optional steps.

In the processes of the above embodiments 12-c and 12-d, the first data configuration request message and the first data configuration response message may be non-user equipment-associated messages, such as a Xn/X2 Setup Request and a Xn/X2 Setup Response message respectively, a NG-RAN Node/eNB Configuration Update and a NG-RAN Node/eNB Configuration Update Acknowledge message respectively; or may also be user equipment-associated messages, such as a S-Node (SgNB) Addition/Modification Request and a S-Node (SgNB) Addition/Modification Response message, or may be newly defined messages.

Embodiment 12-e (Handover scenario, where the fourth node is the source node or the central unit of the source node, or the control plane part of the central unit of the source node, and the fifth node is the target node, or the central unit of the target node, or the control plane part of the central unit of the target node; and the size limit of the control information is set by the source node or the central unit of the source node, or the control plane part of the central unit of the source node)

In this embodiment 12-e, the source node may inform the target node of information of the size allowed when generating control information, such that the target node generates the control information or control signaling messages according to this information. This embodiment 12-e may comprise the following processes:
Step 12-e-1201: The fourth node transmits a first data configuration request message to the fifth node, wherein the message comprises at least one of the following information:
   First capability information, where in one embodiment the information indicates a capability of the fourth node;
   First information indicating a size;
   Second information indicating a size; and
   Second signaling information.
Step 12-e-1202: The fifth node transmits a first data configuration response message to the fourth node, wherein the message comprises at least one of the following information:
   Cause information; and
   First configuration control information, for which please refer to the descriptions in “First Configuration Control Information” for the X2/Xn interface in the above step 1202 in FIG. 12.

In this embodiment 12-e, the target node may determine the generated control information according to the information transmitted by the source node (such as size information of the control information), thereby helping the source node generate a control signaling message of an appropriate size.

Embodiment 12-f (Handover scenario, where the fourth node is the source node or the central unit of the source node, or the control plane part of the central unit of the source node, and the fifth node is the target node, or the central unit of the target node, or the control plane part of the central unit of the target node; and the size limit of the control information is set by OAM)

In this embodiment 12-f, the OAM configures information of the size allowed when the target node generating the control information, such that the target node generates the control information according to this information. This embodiment comprises the following processes:
Step 12-f-1201: The fourth node transmits a first data configuration request message to the fifth node, wherein the message comprises at least one of the following information:
   First ability information; and
   Second signaling information
Step 12-f-1202: The fifth node transmits a first data configuration response message to the fourth node, wherein the message comprises at least one of the following information:
   Cause information; and
   First configuration control information, for which please refer to the descriptions in “First Configuration Control Information” for the X2/Xn interface in the above step 1202 in FIG. 12.

In this embodiment 12-f, the target node may determine the size of the generated control information according to the configuration by the OAM, thereby helping the source node generate a control signaling message of an appropriate size.

In an optional embodiment, the above steps 12-e-1202 and 12-f-1202 may be optional steps.

In the processes of the above embodiments 12-e and 12-f, the first data configuration request message and the first data configuration response message may be non-user equipment-associated messages, such as Xn/X2 Setup Request and Xn/X2 Setup Response messages, NG-RAN Node/eNB Configuration Update and NG-RAN Node/eNB Configuration Update Acknowledge messages, or may be user equipment-associated messages, such as Handover Request and Handover Request Acknowledge messages, or may be newly defined messages.

In embodiments 13-g, 13-h, 13-i and 13-j, example flowcharts for dual connectivity scenarios and handover scenarios are respectively given, wherein in the same scenarios, the size limit of the control information may be set by different entities. FIG. 13 shows a flowchart of an example method associated with the embodiments 13-g, 13-h, 13-i and 13-j. The method comprises: the sixth node transmitting a second data configuration request message to the fourth node (1301), the fourth node transmitting a first data configuration request message to the fifth node (1302), the fifth node transmitting a first data configuration response message to the fourth node (1303), and the fourth node transmitting a second data configuration response message to the sixth node (1304).

Description is made below with respect to different scenarios and different size restriction setting subjects.

Embodiment 13-g (dual connectivity scenario, where the fourth node is the central unit of the secondary node or the control plane part of the central unit, the fifth node is the distributed unit of the secondary node, and the size restriction of the control information is set by the master node, the central unit of the master node, or the control plane part of the central unit of the master node)

This embodiment 13-g also involves a sixth node, which may be the master node or the central unit of the master node, or the control plane part of the central unit of the master node. This embodiment 13-g comprises the following processes:

Step 13-g-1301: The sixth node transmits a second data configuration request message to the fourth node, wherein the message comprises at least one of the following information:
First capability information, which indicates a capability of the sixth node;
First information indicating a size, which indicates an allowed size of control information when the secondary node generates the control information, that is, a total size of the control information generated by the fourth node and the fifth node;
Second information indicating a size, which indicates a size of control information reserved by the sixth node, and the reserved control information is generated by the sixth node; and
Second signaling information, which contains a control signaling message (such as CG-ConfigInfo) generated by the sixth node.

For the content contained in the above information, please refer to the descriptions in the above step 1201 in FIG. 12.

Step 13-g-1302: The fourth node transmits a first data configuration request message to the fifth node, wherein the message comprises at least one of the following information:
First capability information, which indicates a capability of the sixth node;
First information indicating a size, which indicates an allowed size of control information when the fifth node generates the control information;
Second information indicating a size, which indicates a size of reserved control information. In one embodiment, the reserved control information is generated by the fourth node. In another embodiment, the reserved control information is generated by the fourth node and the fifth node; and
Second signaling information. Information or part of the information contained in this information is received through the above step 13-g-1301 (such as the second signaling information contained in the step 13-g-1301).

For the content contained in the above information, please refer to the descriptions in the above step 1201 in FIG. 12.

Step 13-g-1303: The fifth node transmits a first data configuration response message to the fourth node, wherein the message comprises at least one of the following information:
Cause information; and
First configuration control information, for which please refer to the descriptions in “First Configuration Control Information” for the F1 interface in the above step 1202 in FIG. 12.

Step 13-g-1304: The fourth node transmits a second data configuration response message to the sixth node, wherein the message comprises at least one of the following information:
Cause information; and
First configuration control information, for which please refer to the descriptions in the “First Configuration Control Information” for the X2/Xn interface in the above step 1202 in FIG. 12. The content contained in this information may comprise the information contained in step 13-a-3.

In this embodiment 13-g, the central unit of the secondary node and the distributed unit of the secondary node may generate control information according to the configuration information of the master node, and then forward it to the master node to generate a control signaling message of an appropriate size.

Embodiment 13-h (dual connectivity scenario, where the fourth node is the central unit of the secondary node or the control plane part of the central unit of the secondary node, the fifth node is the distributed unit of the secondary node, and the size restriction of the control information is set by OAM)

This embodiment further involves a sixth node, which may be the master node or the central unit of the master node, or the control plane part of the central unit of the master node. This embodiment 13-h may comprise the following processes:

Step 13-h-1301: The sixth node transmits a second data configuration request message to the fourth node, wherein the message comprises at least one of the following information:
First capability information, which indicates a capability of the sixth node; and
Second signaling information, which contains a control signaling message (such as CG-ConfigInfo) generated by the sixth node.

For the content contained in the above information, please refer to the descriptions in the above step 1201 in FIG. 12.

Step 13-h-1302: The fourth node transmits a first data configuration request message to the fifth node, wherein the message comprises at least one of the following information:
First capability information, which indicates a capability of the sixth node; and
Second signaling information. Information or part of the information contained in this information is received through the above step 6-h-1 (such as the second signaling information contained in the step 6-h-1).

For the content contained in the above information, please refer to the descriptions in the above step 1201 in FIG. 12.

Step 13-h-1303: The fifth node transmits a first data configuration response message to the fourth node, wherein the message comprises at least one of the following information:
Cause information; and
First configuration control information, for which please refer to the descriptions in “First Configuration Control Information” for the F1 interface in the above step 1202 in FIG. 12.

Step 13-h-1304: The fourth node transmits a second data configuration response message to the sixth node, wherein the message comprises at least one of the following information:
Cause information; and
First configuration control information, for which please refer to the descriptions in “First Configuration Control Information” for the X2/Xn interface of the above step 1202 in FIG. 12. The content contained in this information may comprise the information contained in step 13-g-1303.

In this embodiment 13-h, the central unit of the secondary node and the distributed unit of the secondary node may generate control information according to the configuration by the OAM, and then forward it to the master node to generate a control signaling message of an appropriate size.

In the processes of the above embodiments 13-g and 13-h, the first data configuration request message and the first data configuration response message may be non-user equipment-associated F1 messages, such as a GNB-CU Configuration Update and a GNB-CU Configuration Update Acknowledge message respectively, or may be user equipment-associated F1 messages, such as a UE Context Setup/Modification Request message and a UE Context Setup/Modification Response message respectively, or may be newly defined messages. In an optional embodiment, the above steps 13-g-1303 and 13-h-1303 may be optional steps.

In the processes of the above embodiments 13-g and 13-h, the second data configuration request message and the second data configuration response message may be non-user equipment-associated messages, such as a Xn/X2 Setup Request and a Xn/X2 Setup Response message respectively, a NG -RAN Node/eNB Configuration Update and a NG-RAN Node/eNB Configuration Update Acknowledge message respectively, or may be user equipment-associated messages, such as a S-Node Addition/Modification Request and a S-Node Addition/Modification Response, or may be newly defined messages.

Embodiment 13-i (Handover scenario, where the fourth node is the central unit of the target node or the control plane part of the central unit, the fifth node is the distributed unit of the target node, and the size restriction of the control information is set by the source node or the central unit of the source node or the control plane part of the central unit of the source node)

This embodiment 13-i further involves a sixth node, which may be the source node or the central unit of the source node, or the control plane part of the central unit of the source node. This embodiment 13-i comprises the following processes:

Step 13-i-1301: The sixth node transmits a second data configuration request message to the fourth node, wherein the message comprises at least one of the following information:
First capability information, which indicates a capability of the sixth node; and
First information indicating a size, which indicates an allowed size of control information when the target node generates the control information, that is, a total size of the control information generated by the fourth node and the fifth node; and
Second signaling information, which contains a control signaling message generated by the sixth node (such as HandoverPreparationInformation).

For the content contained in the above information, please refer to the descriptions in the above step 1201 in FIG. 12.

Step 13-i-1302: The fourth node transmits a first data configuration request message to the fifth node, wherein the message comprises at least one of the following information:
First capability information, which indicates a capability of the sixth node;
First information indicating a size, which indicates an allowed size of control information when the fifth node generates the control information;
Second information indicating a size, which indicates a size of the reserved control information. In one embodiment, the reserved control information is generated by the fourth node. In another embodiment, the reserved control information is generated by the fourth node and the fifth node; and
Second signaling information. Information or part of the information contained in this information is received through the above step 13-i-1301 (such as the second signaling information contained in the step 13-i-1301).

For the content contained in the above information, please refer to the descriptions in the above step 1201 in FIG. 12.

Step 13-i-1303: The fifth node transmits a first data configuration response message to the fourth node, wherein the message comprises at least one of the following information:
Cause information; and
First configuration control information, for which please refer to the descriptions in “First Configuration Control Information” for the F1 interface in the above step 1202 in FIG. 12.

Step 13-i-1304: The fourth node transmits a second data configuration response message to the sixth node, wherein the message comprises at least one of the following information:
Cause information; and
First configuration control information, for which please refer to the descriptions in “First Configuration Control Information” for the X2/Xn interface in the above step 1202 in FIG. 12. The content contained in this information may comprise the information contained in step 13-i-1303.

In this embodiment 13-i, the central unit of the target node and the distributed unit of the target node may generate the control information according to the configuration information of the source node, and then forward it to the source node to generate a control signaling message of an appropriate size.

Embodiment 13-j (Handover scenario, where the fourth node is the central unit of the target node or the control plane part of the central unit, the fifth node is the distributed unit of the target node, and the size restriction of the control information is set by OAM)

This embodiment 13-j further involves a sixth node, which may be the source node or the central unit of the source node, or the control plane part of the central unit of the source node. This embodiment 13-j comprises the following processes:

Step 13-j-1301: The sixth node transmits a second data configuration request message to the fourth node, wherein the message comprises at least one of the following information:
First capability information, which indicates a capability of the sixth node; and
Second signaling information, which contains a control signaling message generated by the sixth node (such as HandoverPreparationInformation).

For the content contained in the above information, please refer to the descriptions in the above step 1201 in FIG. 12.

Step 13-j-1302: The fourth node transmits a first data configuration request message to the fifth node, wherein the message comprises at least one of the following information:
First capability information, which indicates a capability of the sixth node; and
Second signaling information. Information or part of the information contained in this information is received through the above step 13-j-1301 (such as the second signaling information contained in step 13-j-1301).

For the content contained in the above information, please refer to the descriptions in the above step 1201 in FIG. 12.

Step 13-j-1303: The fifth node transmits a first data configuration response message to the fourth node, wherein the message comprises at least one of the following information:
Cause information; and
First configuration control information, for which please refer to the descriptions in “First Configuration Control Information” for the F1 interface in the above step 1202 in FIG. 12.

Step 13-j-1304: The fourth node transmits a second data configuration response message to the sixth node, wherein the message comprises at least one of the following information:
Cause information; and
First configuration control information, for which please refer to the descriptions in “First Configuration Control Information” for the X2/Xn interface in the step 1202 in FIG. 12. The content contained in this information may comprise the information contained in step 13-j-1303.

In this embodiment 13-j, the central unit of the target node and the distributed unit of the target node may generate the control information according to the configuration by the OAM, and then forward it to the source node to generate a control signaling message of an appropriate size.

In an optional embodiment, the above steps 13-i-1303 and 13-j-1303 may be optional steps.

In the processes of the above embodiments 13-i and 13-j, the first data configuration request message and the first data configuration response message may be non-user equipment-associated F1 messages, such as GNB-CU Configuration Update and GNB-CU Configuration Update Acknowledge messages, or may be user equipment-associated F1 messages, such as a UE Context Setup/Modification Request message and a UE Context Setup/Modification Response message respectively, or may be newly defined messages.

Embodiment 14-k (CU-DU, transmitting a message containing multiple segments)

This embodiment 14-k occurs between the central unit and the distributed unit of the base station. When a RRC message is segmented, the central unit of the base station may transmit all the segments of the message to the distributed unit through a F1AP message, and then the distributed unit may transmit the segments to a user equipment one by one. The advantage of this is to speed up the transmission of the control signaling messages. FIG. 14 shows a flowchart of an example method associated with the embodiment 14-k. This embodiment of FIG. 14 may comprise the following processes:

Step 1401: The fourth node transmits a first data configuration request message to the fifth node, wherein the message comprises at least one of the following information:
First signaling information, which contains multiple segments of a first control signaling message.

Step 1402: The fifth node transmits the received control signaling messages to the user equipment one by one.

In the above process, the first data configuration request message may be a DL RRC Message Transfer message of the F1 interface, or may be other information.

Beneficial effects of the sixth aspect of the present disclosure comprise:
-The distributed unit of the base station or the target base station or the secondary node may generate the control information in the RRC message according to configurations, so as to ensure that the eventually generated RRC message does not exceed its size limit, and is transmitted to the user equipment, which may avoid reconfiguration of the user equipment due to an inappropriate size of the message; and
-When the size of the RRC message is restricted, the distributed unit of the base station or the target base station or the secondary node may generate one or more control information of an appropriate size according to the configurations, and the central unit of the base station or the source base station or the master node may generate one or more RRC messages of an appropriate size and transmit them to the user equipment, which may avoid reconfiguration of the user equipment due to inappropriate sizes of the messages.

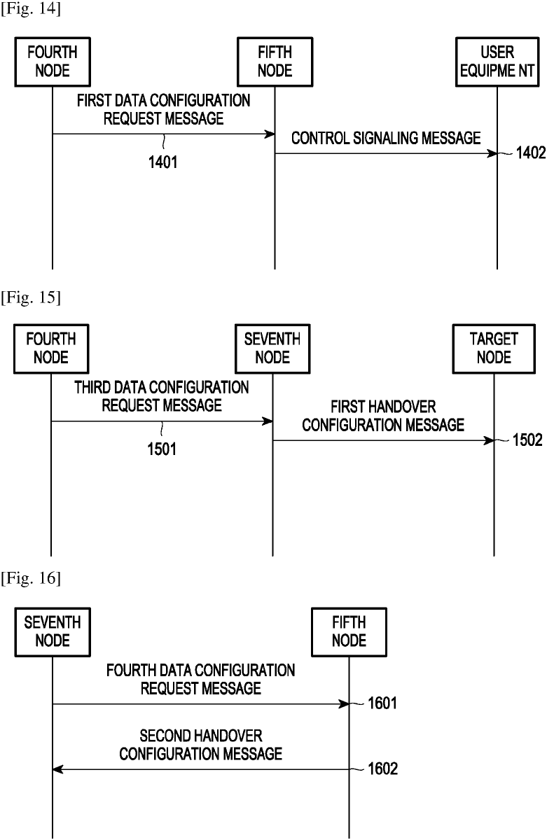

Embodiment 15-1, for the handover scenario, when there is no Xn/X2 interface between the source node and the target node, in order to transmit the configuration information required to generate the control information, a seventh node is further involved, which is a node of the core network, such as AMF and MME, and which may forward the configuration information required to generate the control information from the source node to the target node. FIG. 15 shows a flowchart of an example method associated with the embodiment 15-1. In this flowchart, the following processes may be included:

1) Interaction process between fourth node (such as source node) and seventh node:

Step 1501 of FIG. 15: The fourth node transmits a third data configuration request message to the seventh node, wherein the message is used to transmit configuration information related to user equipment’s handover. For the content contained in the message, please refer to Handover Required message in TS38.413 or TS36.423. In addition, this message may further include at least one of the following information:
First capability information, which indicates a capability of the fourth node. For the content contained in this information, please refer to the “first capability information” in the above step 1202 in FIG. 12;
First information indicating a size. For the content contained in this information, please refer to the “first information indicating a size” in the above step 1202 in FIG. 12;
Second information indicating a size. For the content contained in this information, please refer to the “second information indicating a size” in the above step 1202 in FIG. 12; and
Second signaling information. For the content contained in this information, please refer to “Second Signaling Information” in the above step 1202 in FIG. 12.

Step 1502 of FIG. 15: After receiving the above message, the seventh node may transmit a first handover configuration message related to the handover to the target node. In the step 1502, the target node may be the fifth node.

2) Interaction process between seventh node and fifth node (such as target node):

FIG. 16 shows a flowchart of an example method.

Step 1601 of FIG. 16: The seventh node transmits a fourth data configuration request message to the fifth node, wherein the message is used to transmit configuration information related to user equipment’s handover. For the content contained in the message, refer to Handover Request message in TS38.413 or TS36.423. In addition, this message may further include at least one of the following information:
First capability information, which indicates a capability of the source node. For the content contained in this information, please refer to the “first capability information” in the above step 1202 in FIG. 12;
First information indicating a size. For the content contained in this information, please refer to the “first information indicating a size” in the above step 1202 in FIG. 12;
Second information indication a size. For the content contained in this information, please refer to the “second information indicating a size” in the above step 1202 in FIG. 12; and
Second signaling information. For the content contained in this information, please refer to “Second Signaling Information” in step 1202 above.

Step 1602 of FIG. 16: After receiving the above message, the fifth node may generate a second handover configuration message related to the handover and transmit it to the seventh node.

The beneficial effect of the above two processes is that during the handover process, if the handover on the X2/Xn interface cannot be performed, the above two processes may transfer the configuration information that generates the control signaling message, thereby avoiding the size of the control signaling message from exceeding the limit, since exceeding the limit may in turn make it impossible to configure the user equipment.

Each node according to embodiments of the present disclosure may operate as a transmitting node or a receiving node, and the transmitting node or the receiving node may be implemented by including a transceiver and a processor configured to control an operation according to one or more embodiments in the above FIG. 1 to FIG. 16.

According to another aspect of the present disclosure, one of the advantages of the present disclosure is to ensure that the size of the control signaling message does not exceed the limit among multiple nodes.

A data transmission method among multiple nodes that ensures a size of a control signaling message does not exceed a limit is provided, the method comprising: receiving by a fifth node a configuration request message from a fourth node; and transmitting by the fifth node a configuration response message to the fourth node.

The configuration request message may be a first data configuration request message. The first data configuration request message is used to notify the fifth node of configuration information required in generating information in the control signaling message.

wherein the first data configuration request message comprises at least one of the following information: first capability information, which is used to indicate whether a node that generates the control signaling message has an ability to perform segmentation; first information indicating a size, which is used to indicate an allowed size of the control information when the fifth node generates the control information; second information indicating a size, which is used to indicate a size of the control information generated by the fourth node; first signaling information, which contains a first control signaling message and/or a second control signaling message generated by the fourth node; and second signaling information, which contains control signaling messages generated by other nodes.

In a further embodiment, the first signaling information may comprise multiple containers, each of which may comprise a second control signaling message that carries a segment of the first control signaling message;

Wherein the configuration response message may be a first data configuration response message, which is used to notify the fourth node of information in the control signaling message generated, and the message comprises at least one of the following information: cause information, a function of which is to indicate cause information of the information contained in the first data configuration response message; and first configuration control information, which is configuration information generated by the fifth node, and information contained in this configuration information may be included in the first control signaling message or the second control signaling message and then transmitted to a user equipment.

In a further embodiment, in the case of the F1 interface, the first configuration control information may comprise multiple DU to CU RRC Information IEs, and these IEs include all the control information required to configure the user; while in the case of the Xn/X2 interface, the first configuration control information may include multiple Secondary Node to Master Node container IEs, and these IEs contain all the control information required to configure the user equipment.

In an embodiment, the fourth node and the fifth node may be a central unit (or control plane part of the central unit) of the base station and a distributed unit of the base station, respectively, and a size limit of the control information generated by the distributed unit is configured by the central unit.

In another embodiment, the information of a size allowed when the distributed unit of the base station generates the control information is configured by OAM, and therefore, the distributed unit may generate control information based on this information.

In another embodiment, the fourth node and the fifth node may be a master node and a secondary node, respectively, or a source node and a target node, respectively.

In another embodiment, the fourth node and the fifth node may be a master node and a secondary node, respectively, or a source node and a target node, respectively, wherein OAM configures the information of the size allowed when the secondary node (or target node) generate the control information.

In another embodiment, the fourth node and the fifth node may be central units (or control plane part of the central units) of a master node (or a source node) and a secondary node (or a target node), respectively; or may be a central unit (or control plane part of the central unit) of a secondary node (or a target node) and a distributed unit of the secondary node (or a target node), respectively.

In another embodiment, the fourth node and the fifth node may be central units (or control plane part of the central units) of a master node (or source node) and a secondary node (or target node), respectively; or may be a central unit (or control plane part of the central unit) of a secondary node (or a target node) and a distributed unit of the secondary node (or the target node), respectively, wherein, a size limit of the control information is set by OAM.

In an embodiment, a method comprises: transmitting by a fourth node a first data configuration request message to a fifth node; and transmitting by the fifth node the received control signaling messages to a user equipment one by one;

Wherein the fourth node and the fifth node may be a central unit and a distributed unit of a base station, respectively.

In a further embodiment, the first data configuration request message comprises first information containing a plurality of segments of the first control signaling message.

In an embodiment, the first data configuration request message may be a DL RRC Message Transfer message of the F1 interface.

In one embodiment, for a dual connectivity scenario, the fourth node may be a master node (or a central unit of the master node, or control plane part of the central unit of the master node), and the fifth node may be a secondary node (or a central unit of the secondary node, or control plane part of the central unit of the secondary node).

In another embodiment, for a handover scenario, the fourth node may be a source node (or a central unit of the source node, or control plane part of the central unit of the source node), and the fifth node may be a target node (or a central unit of the target node, or control plane part of the central unit of the target node).

In another embodiment, the first data configuration request message and the first data configuration response message may be non-user equipment-associated messages. Specifically, they may be: a Xn/X2 Setup Request and a Xn/ X2 Setup Response message, a NG-RAN Node/eNB Configuration Update and a NG-RAN Node/eNB Configuration Update Acknowledge message, respectively. In an alternative embodiment, the first data configuration request message and the first data configuration response message may be user equipment-associated messages. Specifically, they may be: a Handover Request and a Handover Request Acknowledge messages respectively. In an alternative embodiment, the first data configuration request message and the first data configuration response message may be newly defined messages.

In various embodiments, for a base station with a CU-DU split architecture, the fourth node may be a central unit of the base station, and the fifth node may be a distributed unit of the base station.

According to another aspect of the present disclosure, a method is provided, the method comprising: transmitting by a sixth node a second data configuration request message to a fourth node, transmitting by the fourth node a first data configuration request message to a fifth node, transmitting by the fifth node a first data configuration response message to the fourth node, and transmitting by the fourth node a second data configuration response message to the sixth node.

In a further embodiment, the size limit of the control information used to generate a control signaling message of an appropriate size is set by the master node and/or the central unit of the master node or the control plane part of the central unit of the master node and/or OAM.

In a further embodiment, the sixth node may be a source node or the central unit of the source node, or the control plane part of the central unit of the source node, the fourth node may be the central unit of the target node or the control plane part of the central unit, and the fifth node may be the distributed unit of a target node.

In a further embodiment, the size limit of the control information used to generate a control signaling message of an appropriate size is set by the source node and/or the central unit of the source node and/or the control plane part of the central unit of the source node and/or the OAM.

In a further embodiment, the sixth node may be the master node or the central unit of the master node, or the control plane part of the central unit of the master node, the fourth node may be the central unit of the secondary node or the control plane part of the central unit, and the fifth node may be the distributed unit of the secondary node.

In a further embodiment, the first data configuration request message and the first data configuration response message may be non-user equipment-associated F1 messages. Specifically, they may be: a GNB-CU Configuration Update and a GNB-CU Configuration Update Acknowledge message respectively. In an alternative embodiment, the first data configuration request message and the first data configuration response message may be user equipment-associated F1 messages. Specifically, they may be: a UE Context Setup/Modification Request message and a UE Context Setup/Modification Response message, respectively. In an alternative embodiment, the first data configuration request message and the first data configuration response message may be newly defined messages.

In a further embodiment, the second data configuration request message and the second data configuration response message may be non-user equipment-associated messages. Specifically, they may be: a Xn/X2 Setup Request and a Xn/X2 Setup Response message, respectively; or they may be: NG-RAN Node/eNB Configuration Update and NG-RAN Node/eNB Configuration Update Acknowledge message, respectively. In an alternative embodiment, the second data configuration request message and the second data configuration response message may also be user equipment-associated messages. Specifically, they may be: a S-Node Addition/Modification Request and S-Node Addition/Modification Response message, respectively; or they may be: a Handover Request and a Handover Request Acknowledge message, respectively. In an alternative embodiment, the second data configuration request message and the second data configuration response message may also be newly defined messages. According to another aspect of the present disclosure, there is provided a method, the method comprising: transmitting by a fourth node a third data configuration request message to a seventh node, the message being used to transmit configuration information related to user equipment’s handover; and after receiving the above message, transmitting by the seventh node a first handover configuration information related to the handover to a target node.

In a further embodiment, the seventh node may be a node of the core network, which comprises at least one of the following: AMF and MME.

In a further embodiment, the third data configuration request message may be a Handover Required message in TS38.413 or TS36.423.

According to another aspect of the present disclosure, there is provided a method, the method comprising: transmitting a fourth data configuration request message by a seventh node to a fifth node, the message being used to transmit configuration information related to user equipment’s handover; and after receiving the above message, generating by the fifth node second handover configuration information related to the handover.

In a further embodiment, the seventh node is a node of the core network, and comprises at least one of the following: AMF and MME.

In a further embodiment, the fourth data configuration request message may be a Handover Request message in TS38.413 or TS36.423.

1. A method performed by a receiving node in a communication system supporting integrated access and backhaul (IAB), the method comprising:
receiving a configuration request message from a transmitting node; and
performing configuration of data duplication on a radio bearer based on the received configuration request message.

2. The method of claim 1, wherein the configuration request message is a first resource configuration request message, and wherein the first resource configuration request message comprises at least one of the following:
first configuration information related to the radio bearer; and
first configuration information related to a backhaul link channel, for the receiving node to generate configuration information related to the backhaul link channel.

3. The method of claim 2, wherein the first configuration information related to the radio bearer comprises at least one of the following: first information related to a tunnel of the radio bearer, information related to an access link, information related to the backhaul link channel, and mapping relationship information.

4. The method of claim 2, wherein the first configuration information related to the backhaul link channel comprises at least one of the following: information of a group of backhaul link channels, and configuration information of the backhaul link channels.

5. The method of claim 1, wherein the configuration request message is a second resource configuration request message, which is used to notify the receiving node of configuration information about downlink data transmission,
wherein the second resource configuration request message comprises at least one of the following: identification information of the radio bearer and information related to a tunnel of the radio bearer.

6. The method of claim 5, wherein the information related to the tunnel of the radio bearer comprises at least one of the following: an Internet Protocol (IP) address, a tunnel endpoint identifier of data, indication information of use of a tunnel, one or more Quality of Service (QoS) mapping information, and information related to duplication of a data packet.

7. The method of claim 1, wherein the configuration request message is a first configuration message, which is used to help the receiving node determine a transmission method of user data on an access link.

8. The method of claim 7, wherein the first configuration message comprises at least one of:
indication information of duplication of data; and
indication information of a number of copies to be duplicated into.

9. The method of claim 1, wherein the configuration request message is a second configuration message, which is used to help the receiving node determine a transmission method of user data on a backhaul link channel.

10. The method of claim 9, wherein the second configuration message comprises at least one of the following:
indication information of duplication of data; and
indication information of a number of copies to be duplicated into.

11. A receiving node in a communication system supporting integrated access and backhaul (IAB), comprising:
a transceiver; and
a processor configured to:
receive a configuration request message from a transmitting node through the transceiver, and
perform configuration of data duplication on a radio bearer based on the received configuration request message.

12. (canceled)

13. A transmitting node in a communication system supporting integrated access and backhaul (IAB), the transmitting node comprising:
a transceiver; and
a processor configured to transmit a configuration request message to a receiving node through the transceiver,
wherein the configuration request message comprising a message for the receiving node to perform configuration of data duplication of radio bearer.

14. The transmitting node of claim 13, wherein the transmitting node is a central unit of an anchor node, control plane part of the central unit of the anchor node, or user plane part of the central unit of the anchor node.

15. The receiving node of claim 11, wherein the configuration request message is a first resource configuration request message, and wherein the first resource configuration request message comprises at least one of the following:
first configuration information related to the radio bearer; and
first configuration information related to a backhaul link channel, for the receiving node to generate configuration information related to the backhaul link channel.

16. The receiving node of claim 15, wherein the first configuration information related to the radio bearer comprises at least one of the following: first information related to a tunnel of the radio bearer, information related to an access link, information related to the backhaul link channel, and mapping relationship information.

17. The receiving node of claim 15, wherein the first configuration information related to the backhaul link channel comprises at least one of the following: information of a group of backhaul link channels, and configuration information of the backhaul link channels.

18. The receiving node of claim 11, wherein the configuration request message is a second resource configuration request message, which is used to notify the receiving node of configuration information about downlink data transmission,
wherein the second resource configuration request message comprises at least one of the following: identification information of the radio bearer and information related to a tunnel of the radio bearer.

19. The receiving node of claim 18, wherein the information related to the tunnel of the radio bearer comprises at least one of the following: an Internet Protocol (IP) address, a tunnel endpoint identifier of data, indication information of use of a tunnel, one or more Quality of Service (QoS) mapping information, and information related to duplication of a data packet.

20. The receiving node of claim 11, wherein the configuration request message is a first configuration message, which is used to help the receiving node determine a transmission method of user data on an access link.

21. The receiving node of claim 20, wherein the first configuration message comprises at least one of:
indication information of duplication of data; and
indication information of a number of copies to be duplicated into.
